(19) United States
(12) Patent Application Publication
(10) Pub. No.: US 2005/0203872 A1
(43) Pub. Date: Sep. 15, 2005

(54) Method and apparatus making, operating and using media parsers to mark, read, and unmark instances of media formats supporting one, two and multi-dimensional instances and data streams

(76) Inventor: John Man Kwong Kwan, Sunnyvale, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/075,377

(22) Filed: Mar. 7, 2005

Related U.S. Application Data
(60) Provisional application No. 60/550,831, filed on Mar. 5, 2004.

(51) Int. Cl. G06F 7/00

(52) U.S. Cl. 707/1

(57) ABSTRACT

A method that generates a media parser for a media format from a statistical profile list. It further generates at least one of a marker, mark reader, and unmarker, from a mark profile list. Media format engines, are products of the process. Some products mark media format instances, to create marked media format instances, with readable, removable marking messages, authenticating and recreating unmarked media format instances. Some products mark with copyright data. Some mark with authenticating copyright data, authenticating copyright applicability. Some operate within existing digital cameras, audio recording devices, and/or video cameras. Digital cameras, audio recording devices, and/or video cameras based upon some products can mark in accord with the invention. Some support business methods accounting for marked media format instances. The invention includes doing business, providing media users with marked media format instances, insuring copyright holder payment.

### CROSS REFERENCES TO PRIORITY DOCUMENTS

This application claims the benefit of the priority date of U.S. provisional application Ser. No. 60/550,831, filed Mar. 5, 2004, which is further hereby incorporated by reference.

This application also incorporates by reference in their entirety the following applications: U.S. Pat. No. 6,792,535 issued Sep. 14, 2005; U.S. Pat. No. 6,434,701 issued Aug. 13, 2002; U.S. patent application Ser. No. 10/828,956 filed Apr. 20, 2004; U.S. patent application Ser. No. 10/102,507 filed Mar. 19, 2002; U.S. provisional application Ser. No. 60/174,301 filed Jan. 3, 2000; provisional application Ser. No. 60/259,497 filed Jan. 2, 2001; and provisional application Ser. No. 60/296,820 filed Jun. 7, 2001.

### FIELD OF THE INVENTION

The present invention relates to embedded authentication and/or copyright data in instances of media formats supporting one or more dimensional data and data streams.

### BACKGROUND OF THE INVENTION

The book entitled “Applied Cryptography Second Edition: protocols, algorithms, and source code in C” by Bruce Schneier, © 1996 will be considered herein as a reasonable example of the knowledge which one commonly skilled in the art of cryptography possesses. It provides a systematic introduction into cryptography, from the inventor's perspective of the background of the prior art.

Over the last fifteen decades, copyrights have been the basis of protection for the compensation of artists, the news media, and their publishing enterprises. In the last decade, a challenge has arisen to this protection in the form of cheap, easy to use, readily available tools which support copying and distributing copyrighted works. The users of these new tools have often shown a complete disregard for the rights of the copyright holders.

New methods of enforcing copyrights are needed. These methods need to be able to determine the original copyright holders, as well as the chain of provenance for a copyrighted work. These methods need to be able to assess the copyrighted work in a wide variety of formats, in which that work may be found. The wide variety of formats possesses a series of problems to copyright enforcement. These problems will be explored by a small set of examples to show some of the complexity involved.

One dimensional data streams include what are known as digital audio formats. Digital audio formats include a host of standards, including a format popularly known as “MP3”, which stands for the MPEG 1, Layer 3 audio format, formulated by MPEG standards committee. As the name implies, there are other MPEG audio layer formats, as well as a number of other digital audio formats. How does one inject a copyright mark, much less a copyright provenance, and hope to have it stick to the audio content, particularly when the audio content may be edited or reformatted? How do such marks persist, when the audio content is played, and then recorded on other equipment? Today, there is no clear and consistent answer for these questions.

Two-dimensional data is commonly considered as still frames. These digital still frames also have numerous still frame standards. Examples of such standards include JPEG and JPEG 2000. These two standards apply different transforms to the raw two-dimensional data. The JPEG standard uses an 8 point by 8 point Discrete Cosine Transform (DCT), while the JPEG 2000 standard uses one of two wavelet transform filters. The transformed data may be compressed using a technique known as quantization before bit packing. The quantization may be differ throughout the 8 by 8 DCT transform data, as well as, it may differ between different pixel components of the two-dimensional data. The pixel component definitions may vary.

Typical pixel component definitions include, but are not limited to, the following. RGB (Red-Green-Blue) components used directly on many electronic display devices. World Wide Web two-dimensional data often uses pixels encoded in a limited set of 256 colors. Some images are gray scale (JFIF), varying from black to white in anywhere from 64 to 4,096 steps. CMYK, which stands for Cyan-Magenta-Yellow-blacK, is a color space favored by many digital cameras, which target accurate reproduction on color printers. What the human eye sees is often modeled in terms of luminance and chrominance. Luminance represents the brightness or intensity of a color. Chrominance represents the specific color perceived. And there are others.

How one injects a mark into the two-dimensional content that survives editing and/or format conversion presents challenges. In the extreme, the format conversion may involve the printing the content to paper or film, then recapturing an image based upon the printed version of the content. The mark may be injected into a color document, and that document may be recaptured in gray scale. The document may be rotated and/or cropped. The document may be in the JPEG standard using a specially constructed quantization scheme. The recaptured document may be in the JPEG 2000 standard.

Even assuming the mark survives in some form, what is that form? How does one find the mark when there is no certainty as to the media format? The evolution of media formats compounds the already mentioned problems. Just as the MP3 format is the de facto audio standard of this time, another standard may supplant it. Today, video on demand is barely possible with existing MPEG media formats. A new motion video format, with dramatically reduced bandwidth requirements, might well add new support requirements for copyrighted material already in distribution.

Today, there is also a rapidly growing need to identify the chain of handling for digital files used in judicial processes. These judicial processes may include criminal cases, insurance claims, as well as other commercial and/or civil processes. In such cases, watermarks which can authenticate a digital file as being unmodified must additionally be able to be reliably removed to restore the digital file to an unmarked condition which closely matches the original digital file.

Another recent problem regarding copyright watermarks is the possibility of embedding false watermarks, which can greatly confuse the copyright ownership. What is needed is a way to authenticate copyright watermarks.

### SUMMARY OF THE INVENTION

The present invention includes a method generating a media parser for a media format based upon a statistical profile list. The statistical profile list includes at least one statistical profile component, which minimally includes at least one region specifier and at least one flatness specifier. The media parser generated by the method includes a region recognizer and a flat area discriminator. The region recognizer is generated based upon at least the region specifier of at least one statistical profile component. The flat area discriminator is generated based upon the region specifier and the flatness specifier. The invention includes the media parser as a product of this generating method. The flatness specifier may include a flatness value and/or a variance.

The generating method can create multiple media parsers for a media format given different statistical profile lists. A single, generated media parser may be a standalone engine, a source code, and/or a program system generated from the source code. The standalone engine may include a computer accessing a memory containing the program system. The source code may further generate the standalone engine.

In certain embodiments, every statistical profile component may be involved in generating at least one region recognizer and/or flat area discriminator. Alternatively, not all of the statistical profile components may be involved in generating the region recognizers and/or the flat area discriminators.

The media parser may include more than one region recognizer. The media parser may include more than one flat area discriminator. By way of example, a media parser for a merged motion video and audio media format, may preferably include separate region recognizers and/or flat area discriminators for the motion video digital stream and the audio digital stream. The media parser may preferably include multiple region recognizers and/or flat area discriminators, one for each digital stream, whether audio or video.

A refinement of the generator method includes generating at least one member of the group consisting of a marker 180, a mark reader 182, and an unmarker 184 first shown in FIG. 7A, each based upon a mark profile list. The mark profile list includes at least one mark profile. Each of the mark profiles includes at least one field mark specifier. Each of the field mark specifiers includes at least one field length and a field encoding specifier. It may be preferred that there are multiple fields, of either the same or at least partially distinct field lengths. By way of example, a copyright provenance mark may include a distributor code field, a purchase date, and a purchaser identifier, all of which may be of differing field lengths, and/or encoded differently.

The invention's method further includes generating a media format engine using at least one member of the marking generator group consisting of operations 372, 382, and 392 of FIG. 7B. Operation 372 generates the marker 180 based upon the statistical profile list and upon the mark profile list. Operation 382 generates the mark reader 182 based upon the statistical profile list and upon the mark profile list. Operation 392 generates the unmarker 184 based upon the statistical profile list and upon the mark profile list.

Each of the engines 800 to 808 of FIGS. 8A to 8F for the media format, is a product of this invention's process. FIGS. 8A to 8F show some of the combinations of the media parser and at least one of the marker, the mark reader, and the unmarker of FIG. 7A. These combinations may be preferred in various applications.

FIGS. 3B, and 9A to 29B provide an enabling overview of the operation of some products of the invention's method. These products support authenticating various instances of media formats, which include any combination of, but are not limited to, instances of two-dimensional content, data streams of one-dimensional content, and data streams of two-dimensional content.

Some products of the invention associated with data authentication, shown in FIGS. 15A to 17B, 21A, 22A, and 23A, provide mechanisms for reliably applying a mark to a media format instance, to create a marked media format instance. The marked media format instance can be read, and the marking message removed, to recreate the unmarked media format instance. The hash codes of the marking message can then be compared with the hash codes recalculated using the unmarked media format instance, to determine if the marked media format instance has been altered.

Some products of the invention associated with copyright stamps, shown in FIGS. 18A to 20B, 21B, 22B, and 23B, provide mechanisms for reliably applying a mark to a media format instance, to create a marked media format instance. The marked media format instance can be read to provide the embedded copyright data, which may include the copyright stamp and/or copyright chain of provenance. The copyright stamp and/or copyright chain of provenance may be used to determine if copyright fees are owed.

Some products of the invention, mark media format instances with authenticating copyright stamps, as shown in FIGS. 21C, 22C, and 23C. These copyright marks can be authenticated to prove they are applicable to the media format instance, and are not falsified copyright watermarks, which may be used by copyright thieves to hide the actual copyright ownership of the media format instance.

FIGS. 25B to 26A show various implementations of the generated media format engines, which can mark a media format instance within existing digital cameras, audio recording devices, and/or video cameras.

FIGS. 26B to 27B show digital cameras, audio recording devices, and/or video cameras in accord with the invention, as products of the method generating a media format engine 804, which can mark a media format instance.

FIGS. 28A to 29A show some products of the invention's process, supporting methods of doing business, accounting for potentially broadcast, marked media format instances. Accounting for the broadcast of marked media format instances has a substantial use in monitoring broadcast of copyrighted material, and/or monitoring the presentation of paid advertisements on specified broadcast channels or communications venues.

FIG. 29B shows a method of doing business, which provides media users with marked media format instances, while insuring payment of the copyright holders. The method also supports the marked media format instances containing a copyright provenance chain, which can additionally determine the media user to bill for illegal copyright distributions.

FIGS. 30A to 30F show various mark field list versions, which support multiple field encoding and/or multiple marks for use with authentication, copyright stamps, and/or copyright chains.

### BRIEF DESCRIPTION OF THE DRAWINGS

FIG. 1A shows a media format engine generator, in accord with the invention creating a media parser directed by a program system and based upon a statistical profile list;

FIG. 1B shows the method generating at least the media parser of FIG. 1A as program steps in the program system;

FIG. 2A shows a detail of FIG. 1B further generating the media parser of FIG. 1A;

FIG. 2B shows the statistical profile list of FIG. 1A may include a second statistical profile component, which may also include a transform specifier;

FIG. 2C shows a transform specifier type list used in transform specifier of FIG. 2B;

FIG. 3A shows a detail of FIG. 2A further generating region recognizer of FIG. 1A;

FIG. 3B shows a means for operating the media parser of FIG. 1A;

FIG. 4A shows the non-overlapping transform list of members referred to in FIG. 2C;

FIG. 4B shows the abutting block transform list of members referred to in FIG. 2C;

FIG. 4C shows the isolated block transform list of members referred to in FIG. 2C;

FIG. 4D shows the finite impulse response transform list of members referred to in FIG. 2C;

FIG. 4E shows the infinite impulse response transform list of members referred to in FIG. 2C;

FIG. 4F shows some details of the media format of FIG. 1A regarding content dimensionality;

FIG. 5A shows the statistical profile list of FIG. 1A including a second statistical profile component, which contains a sample structure;

FIG. 5B shows the transformed media of FIG. 3B including at least two samples;

FIG. 5C shows the audio digital stream list whose members include at least one digital stream of one-dimensional content as in FIG. 4F;

FIG. 5D shows the JPEG format list whose members include at least one instance of two-dimensional content as in FIG. 4F;

FIG. 5E shows the MPEG video standard list whose members include at least one data stream of two-dimensional content as in FIG. 4F;

FIG. 5F shows the region specifier of FIG. 1A including at least one pattern referring to at least one of data streams of one-dimensional content, instances, and/or data streams of two-dimensional content, as in FIG. 4F;

FIG. 5G shows the flat area specifier of FIG. 1A including at least one pattern referring to at least one of data streams of one-dimensional content, instances, and/or data streams of two-dimensional content, as in FIG. 4F;

FIG. 6A shows a detail of the generating of the region recognizer of FIG. 2A;

FIG. 6B shows a detail of the generating of the flat area discriminator of FIG. 2A;

FIG. 7A shows a detail of the media format engine generator of FIG. 1A further using a mark profile list to create at least one of the marker, the mark reader, and the unmarker;

FIG. 7B shows the program system of FIG. 1A further implementing the method of the invention embodied in FIG. 7A;

FIGS. 8A to 8F show media format engines, generated by the invention's method, each of which includes the media parser of FIGS. 1A, and 3B, and at least one of the marker, the mark reader and the unmarker of FIG. 7A;

FIG. 9A shows an alternative embodiment of the media parser of FIGS. 1A, 3B, and FIGS. 8A to 8F;

FIG. 9B shows some details of the media format engine of FIG. 8D;

FIG. 10A shows some details of the marker of FIGS. 7A, 8A to 8F and 9B;

FIG. 10B shows some details of the media format engine of FIG. 8E;

FIG. 11A shows some details of the mark reader of FIGS. 7A, 8A, 8B, 8C, 8E, and 10B;

FIG. 11B shows some details of the media format engine of FIG. 8F;

FIG. 12 shows some details of the unmarker of FIGS. 7A, 8A, 8C, 8F, and 11B;

FIG. 13 shows some details of an alternative embodiment of the media format engine of FIGS. 8D and 9B;

FIG. 14 shows some details of the media format engine of FIG. 8C;

FIG. 15A shows the media format engine of FIGS. 8D, 9B and 13 being used with instances of two-dimensional content as in FIG. 4F to create watermarked digital photos;

FIG. 15B shows the media format engine of FIGS. 8C and 14 being used with the watermarked digital photos of FIG. 15A to authenticate and restore the digital photos;

FIG. 16A shows the media format engine of FIGS. 8D, 9B and 13 being used with data streams of one-dimensional content as in FIG. 4F to create watermarked digital audio files;

FIG. 16B shows the media format engine of FIGS. 8C and 14 being used with the watermarked digital audio files of FIG. 16A to authenticate and restore the digital audio files;

FIG. 17A shows the media format engine of FIGS. 8D, 9B and 13 being used with data streams of two-dimensional content as in FIG. 4F to create watermarked video sequences;

FIG. 17B shows the media format engine of FIGS. 8C and 14 being used with the watermarked video sequences of FIG. 17A to authenticate and restore the video sequences;

FIG. 18A shows the media format engine of FIGS. 8D, 9B and 13 being used to embed copyright data into instances of two-dimensional content as in FIG. 4F to create copyright watermarked digital photos;

FIG. 18B shows the media format engine of FIGS. 8E and 10B being used with the copyright data watermarked digital photos of FIG. 18A to determine whether copyright fees are owed;

FIG. 19A shows the media format engine of FIGS. 8D, 9B and 13 being used to embed copyright data into data streams of one-dimensional content as in FIG. 4F to create copyright watermarked digital audio files;

FIG. 19B shows the media format engine of FIGS. 8E and 10B being used with the copyright watermarked digital audio files of FIG. 19A to determine whether copyright fees are owed;

FIG. 20A shows the media format engine of FIGS. 8D, 9B and 13 being used to embed copyright data into data streams of two-dimensional content as in FIG. 4F to create watermarked video sequences;

FIG. 20B shows the media format engine of FIGS. 8E and 10B being used with the copyright watermarked video sequences of FIG. 20A to determine whether copyright fees are owed;

FIG. 21A shows a digital camera implementing the method of FIG. 15A to create digital photos with watermarks;

FIG. 21B shows a digital camera implementing the method of FIG. 18A to create copyright watermarked digital photos;

FIG. 21C shows a digital camera embedding copyright and hash codes using the media format engine of FIGS. 8D, 9B and 13 to create digital photos with authenticated copyright watermarks;

FIG. 22A shows a digital audio recording device implementing the method of FIG. 16A to create digital audio files with watermarks;

FIG. 22B shows a digital audio recording device implementing the method of FIG. 19A to create copyright watermarked digital audio files;

FIG. 22C shows a digital audio recording device embedding copyright and hash codes using the media format engine of FIGS. 8D, 9B and 13 to create digital audio files with authenticated copyright watermarks;

FIG. 23A shows a video camera implementing the method of FIG. 17A to create digital motion video sequences with watermarks;

FIG. 23B shows a video camera implementing the method of FIG. 20A to create copyright watermarked digital motion video sequences;

FIG. 23C shows a video camera embedding copyright and hash codes using the media format engine of FIGS. 8D, 9B and 13 to create digital motion video sequences with authenticated copyright watermarks;

FIG. 24 shows merging the output of the digital audio recording device of FIG. 22C and the output of the video camera of FIG. 23C to create a multi-media sequence with authenticated copyright watermarks;

FIG. 25A shows a prior art recording devices, such as a digital camera, digital audio recording device, and/or video camera with a corresponding removable memory module;

FIG. 25B shows the prior art recording device of FIG. 25A interfacing through an authenticating/copyright engine with the removable memory module to provide watermarked media format instances;

FIG. 26A shows some details of the authenticating/copyright engine of FIG. 25B;

FIG. 26B shows some details of the digital cameras of FIGS. 21A to 21C;

FIG. 27A shows some details of the digital audio recording devices of FIGS. 22A to 22C and 24;

FIG. 27B shows some details of the video cameras of FIGS. 23A to 24;

FIGS. 28A and 28B shows multi-channel audio and video stream mark reading and accounting systems using the media format engines of FIGS. 8E, 10B, 19B, and 20B;

FIG. 29A shows a business method using at least one of the multi-channel mark reading and accounting systems of FIGS. 28A and 28B to generate revenue;

FIG. 29B shows a business method using at least one of the media format engines of FIGS. 8D, 9B, 13, 15A, 16A, 17A, 18A, 19A, 20A, and 21A to 24;

FIG. 30A shows the field mark specifier of FIG. 7A further including a second field length;

FIG. 30B shows the field mark specifier of FIG. 30A further including a field coupling specifier;

FIG. 30C shows the field mark specifier of FIG. 30B further include a combiner field length;

FIG. 30D shows the mark profile list of FIG. 7A including a second mark profile;

FIG. 30E shows the second mark profile of FIG. 30D further including a mark coupler specifier;

FIG. 30F shows the mark profile list of FIG. 7A including a mark coupler profile;

FIG. 31A shows an alternative embodiment of the method of FIGS. 1A and 2B showing the steps of the method implemented as means for performing those steps;

FIG. 31B shows a detail of the means for implementing the generating the media parser of the preceding Figures;

FIG. 32A shows the flowchart of the generating the media parser of FIGS. 1B, 31A, and 31B;

FIG. 32B shows a detail flowchart of FIG. 7B further generating the marker of the preceding Figures, for at least one of said mark profiles;

FIG. 32C shows a detail flowchart of FIG. 7B further generating said mark reader of FIG. 7A, for at least one of the mark profiles;

FIG. 33A shows a detail flowchart of FIG. 7B further generating said unmarker of FIG. 7A, for at least one of the mark profiles;

FIG. 33B shows the invention's method of FIGS. 1A, 1B, and 7A further generating engines for media formats;

FIG. 33C shows the invention's method of FIGS. 1A, 1B, 7A and 33B, further generating engines for media formats;

FIG. 34A shows an example of a media format instance of a digital photo with some examples of flat areas;

FIG. 34B shows an example of a media format instance of a digital photo with no flat areas;

FIG. 34C shows a transformed media of the media format instance of FIG. 34B which contains isolated peaks surrounded by several flat areas;

FIG. 35A shows the media format instance and the transformed media as an array of data values, which may be a two-dimensional array of pixels;

FIG. 35B shows the media format instance of a one-dimensional audio stream, which may embody a digital audio file;

FIG. 35C shows the transformed media of the media format instance of FIG. 35B showing played notes as flat areas;

FIG. 35D shows an overlay of multiple frames of a motion video sequence with one block indicating that it moves, all labeled blocks may be used as flat areas;

FIG. 36A shows a target area example, for a corresponding mark shown in FIG. 36B, and unmarked area shown in FIG. 36C;

FIGS. 36D, 36E and 36G show some details of a region specifier and pattern of FIGS. 1A and 5F;

FIG. 36F shows some retails of the flatness specifier;

FIG. 36H shows some elements of examples of the mark and core as used in FIG. 36B; and

FIG. 37A shows a target area example, for a corresponding mark shown in FIG. 37B, and unmarked area shown in FIG. 37C.

### DETAILED DESCRIPTION

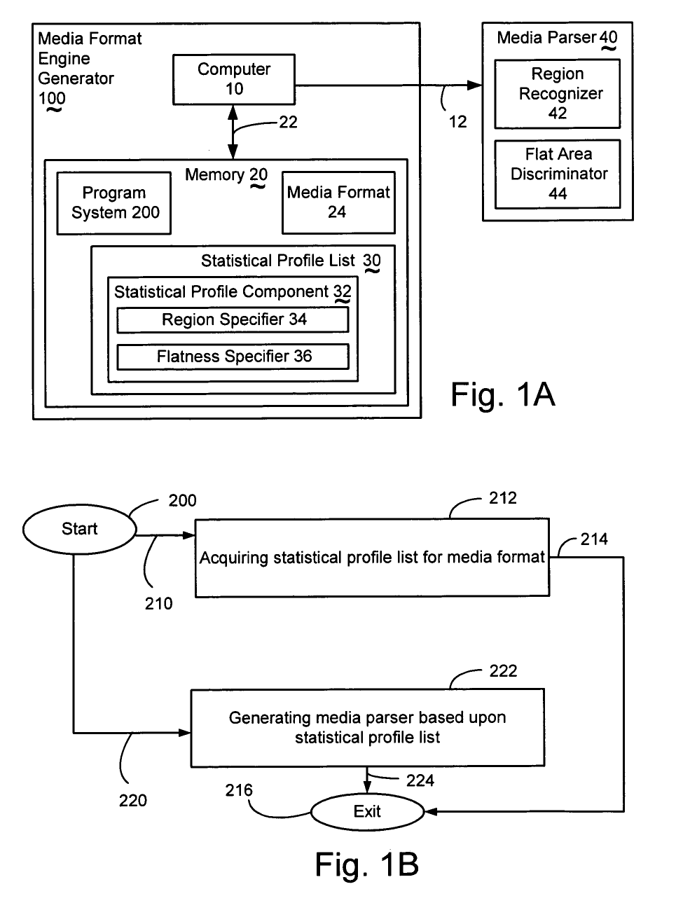

FIG. 1A shows an embodiment of the invention known herein as a media format engine generator 100. The media format engine generator 100 generates 12 a media parser 40 for a media format 24, which includes a region recognizer 42 and a flat area discriminator 44.

In FIG. 1A, a computer 10 is preferably accessibly coupled 22 to a memory 20. The memory 20 may include at least memory content. As used herein memory content of memory 20 may be any combination of non-volatile memory content and volatile memory content. Memory content is volatile if it changes state whenever the memory 20 loses power. Memory content is nonvolatile if it retains its state irrespective of whether the memory 20 is powered. These terms will be used for any form of memory referred to herein.

In FIG. 1A, the media format engine generator 100 further includes a media format 24. The media format 24 preferably resides in the memory 20. The media format engine generator 100 further includes a statistical profile list 30 for the media format 24.

Some of the following figures show flowcharts of at least one method of the invention, possessing arrows with reference numbers. These arrows will signify of flow of control and sometimes data supporting implementations including at least one program operation or program thread executing upon a computer, inferential links in an inferential engine, state transitions in a finite state machine, and dominant learned responses within a neural network.

The operation of starting a flowchart will be designated by an oval with the text “Start” in it, and refers to at least one of the following. Entering a subroutine in a macro instruction sequence in a computer. Entering into a deeper node of an inferential graph. Directing a state transition in a finite state machine, possibly while pushing a return state. And triggering a collection of neurons in a neural network.

The operation of termination in a flowchart will be designated by an oval with the text “Exit” in it, and refers to at least one or more of the following. The completion of those operations, which may result in a subroutine return, traversal of a higher node in an inferential graph, popping of a previously stored state in a finite state machine, return to dormancy of the firing neurons of the neural network.

A computer as used herein will include, but is not limited to an instruction processor. The instruction processor includes at least one instruction processing element and at least one data processing element, each data processing element controlled by at least one instruction processing element. The data processing elements may act upon data based upon access by address or based upon content. Computers acting upon data based upon content are often referred to as content addressable parallel processors.

FIG. 1B shows the method of generating the media parser 40 for the media format 24 as program steps for the program system 200 of FIG. 1A. Other implementations of the invention's method will be presented later as means for implementing the method's process steps. The discussion will focus on the method implemented as a program system directing a computer strictly to facilitate and simplify the discussion. This focus is not meant to limit the scope of the claims, which point out the implementation of the method may be carried out not only with one or more computers. The invention's methods may be implemented with any combination of computers, finite state machines, inferential engines, and neural networks.

In FIG. 1B, operation 212 acquires the statistical profile list 30 of FIG. 1A for the media format 24. The statistical profile list 30 includes at least one statistical profile component 32. Each of the statistical profile components 32 includes a region specifier 34, and a flatness specifier 36. Operation 222 generates 12 the media parser 40 of FIG. 1A based upon the statistical profile list 30.

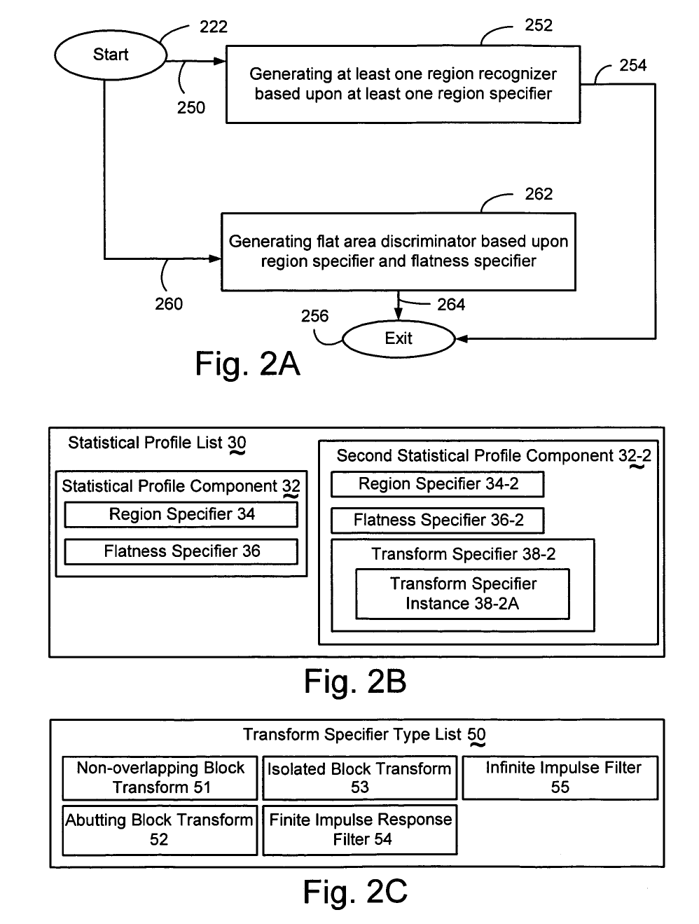

FIG. 2A shows a detail of FIG. 1B further generating 222 the media parser 40 of FIG. 1A. Operation 252 generates at least one region recognizer 42 based upon at least one of the region specifiers 34, included in at least one of the statistical profile components 32. Operation 262 generates a flat area discriminator 44 based upon the region specifier 34 and the flatness specifier 36.

The statistical profile list 30 of FIG. 1A may include a second statistical profile component 32-2 as in FIG. 2B. The statistical profile component 32-2 may also include a transform specifier 38-2. The transform specifier 38-2 may include a transform specifier instance 38-2A.

The transform specifier instance 38-2A of FIG. 2B may be a member of a transform specifier type list 50, shown in FIG. 2C. The transform specifier list 50 includes the members of following lists. A non-overlapping block transform list 51. An abutting block transform list 52. An isolated block transform list 53. A finite impulse response filter list 54. And an infinite impulse filter list 55.

It may be preferred that for each statistical profile component 32 of FIG. 1A and/or second statistical profile component 32-2 of FIG. 2B, at least one region recognizer 42 is, at least partly, based upon the region specifier 34.

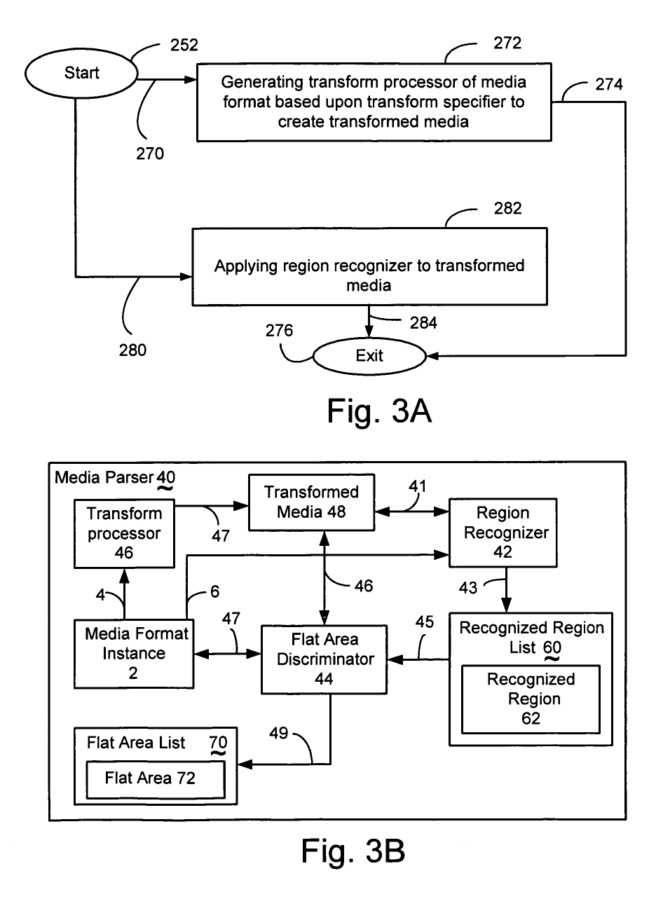

FIG. 3A shows a detail of FIG. 2A further generating 252 the region recognizer 42 of FIG. 1A. Operation 272 supports generating a transform processor 46 of the media format 24 based upon the transform specifier 38-2 to create a transformed media 48, as in FIG. 3B. Operation 282 supports applying the region recognizer 42 to the transformed media 48.

In certain embodiments, the media parser 40 of FIGS. 1A and 3B operates as follows. An instance 2 of a media format 24 may be accessed 6 by the region recognizer 42 to create 43 a recognized region list 60 including at least one recognized region 62. The flat area discriminator 44 receives 45 the recognized region list 60 and accesses 46B the instance 2 of the media format to create 49 a flat area list 70 including at least one flat area 72.

The media parser of FIG. 3B may further include a transform processor 46 creating 47 the transformed media 48, to which the region recognizer 44 is applied 41. The flat area discriminator 44 may access 46A the transformed media 48 in creating 49 the flat area list 70. Alternatively, the flat area discriminator 44 may only access 46A the transformed media 48, without accessing 46B the instance 2. The instance 2 of the media format 24 may further be accessed 4 by the transform processor 48 to create 47 the transformed media 48.

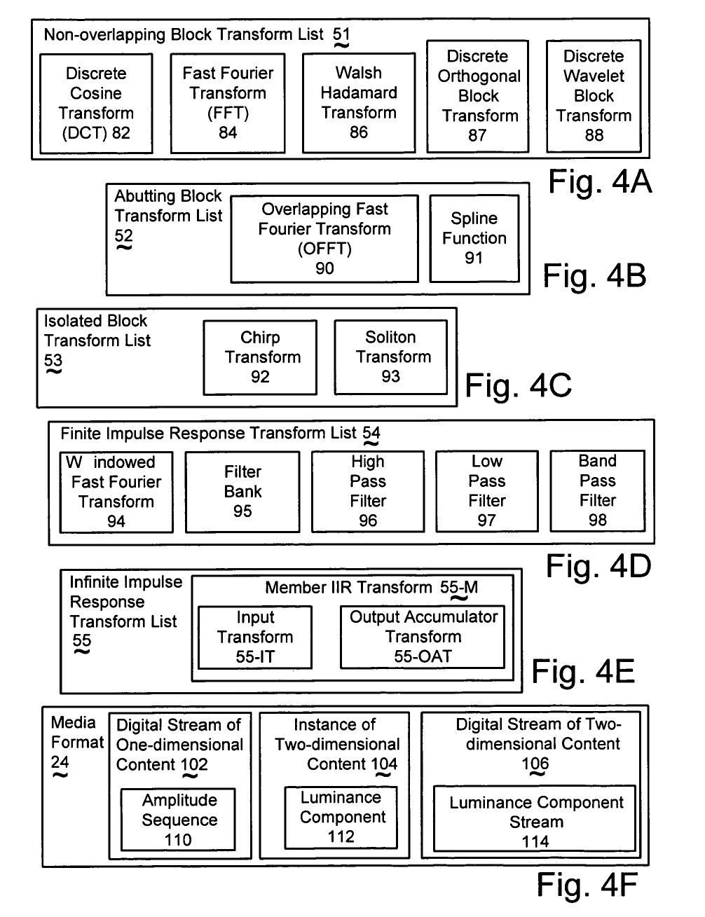

FIG. 4A shows the non-overlapping block transform list 51, of FIG. 2C, including a Discrete Cosine Transform 82 (DCT 82), a Fast Fourier Transform 84 (FFT 84), a Walsh Hadamard Transform 86, a discrete orthogonal block transform 87, and a Discrete Wavelet Block Transform 88. At least one version of the DCT 82 are used in JPEG and MPEG frames. At least one version of the Discrete Wavelet Block Transform 88, is used in JPEG 2000. Multiple versions of the FFT 84 are used in numerous imaging applications including medical imaging. Implementations of the discrete orthogonal block transform 87 are a generalization of the DCT 82, the FFT 84, and the Walsh Hadamard transform 86.

FIG. 4B shows the abutting block transform list 52, of FIG. 2C, including an Overlapping Fast Fourier Transform 90(OFFT 90), and a spline function 91. At least one version of the OFFT 90 is used in various audio media formats including MP3. Versions of the spline function 91 are frequently used in graphics applications, including interactive video games.

FIG. 4C shows isolated block transform list 53, of FIG. 2C, including a chirp transform 92 and a soliton transform 93. Chirp transforms 92 are used in specific calls.

FIG. 4D shows the finite impulse response filter list 54, of FIG. 2C, comprising a Windowed Fast Fourier Transform 94, a filter bank 95, a high pass filter 96, a low pass filter 97, and a band pass filter 98.

FIG. 4E shows each infinite impulse member 55-M of the infinite impulse transform list 55 of FIG. 2C includes an input transform 55-IT and an output accumulator transform 55-OAT.

FIG. 4F shows the media format 24 of FIG. 1A may include any combination of the following: At least one digital stream of a one-dimensional content 102. At least one instance of a two-dimensional content 104. At least one digital stream of a two-dimension content 106.

The digital streams of one-dimensional content 102 of FIG. 4F may further include a digital stream 110 of the amplitude sequence of the one-dimensional content 102. The digital stream 110 may include a power spectrum window of the one-dimensional content 102. Often the digital stream 110 of the power spectrum window of the one-dimensional content 102 will be relatively unaltered in the process of format conversion, as well as playing to record the digital stream 102 for audio content.

An instance of two-dimensional content 104 of FIG. 4F may include a luminance component 112. Often the luminance component 112 refers to the luminance plane of the instance of the two-dimensional content 104. The luminance component 112 tends to be relatively unaltered by the various color space transformations, such as from RGD to gray scale, RGB to CMyk, color wheel rotations, color tintings and filters being applied to the instance of the two-dimensional content 104.

A digital stream of two-dimensional content 106 of FIG. 4F may include a luminance component digital stream 114. As with instances of the two-dimensional content 104, the luminance component digital stream 114 tends to be relatively unaltered by various color space transformations applied to the two-dimensional content digital stream 106.

Multiple implementations of the media format 24 may include multiple instances of digital stream of one-dimensional content 102 shown in FIG. 4F. Examples include multi-channel audio recordings, and DVD media formats.

Multiple implementations of the media format 24 of FIGS. 1A and 4F, may include more than one instance of two-dimensional content 104. Examples include TIFF computer file formats, as well as, many presentations for educational and business communications.

Multiple implementations of the media format 24 of FIGS. 1A and 4F, may include more than one instance of the digital stream of two-dimensional content 106. Example are found in the scenes of a DVD and various computer games.

Multiple implementations of the media format 24 of FIGS. 1A and 4F, may include both one-dimensional content and two-dimensional content. Examples include presentations of instances of two-dimensional content with one or more accompanying digital streams of one-dimensional, often audio, content. Other examples include DVDs with multiple digital audio streams 102 synchronized with at least one digital stream of two-dimensional content 106.

As used herein a multi-dimensional media format will refer to a version of the media format 24, as in FIG. 4F, including any combination of digital streams of one-dimensional content 102, instances of two-dimensional content 104, and digital streams of two-dimensional content 106.

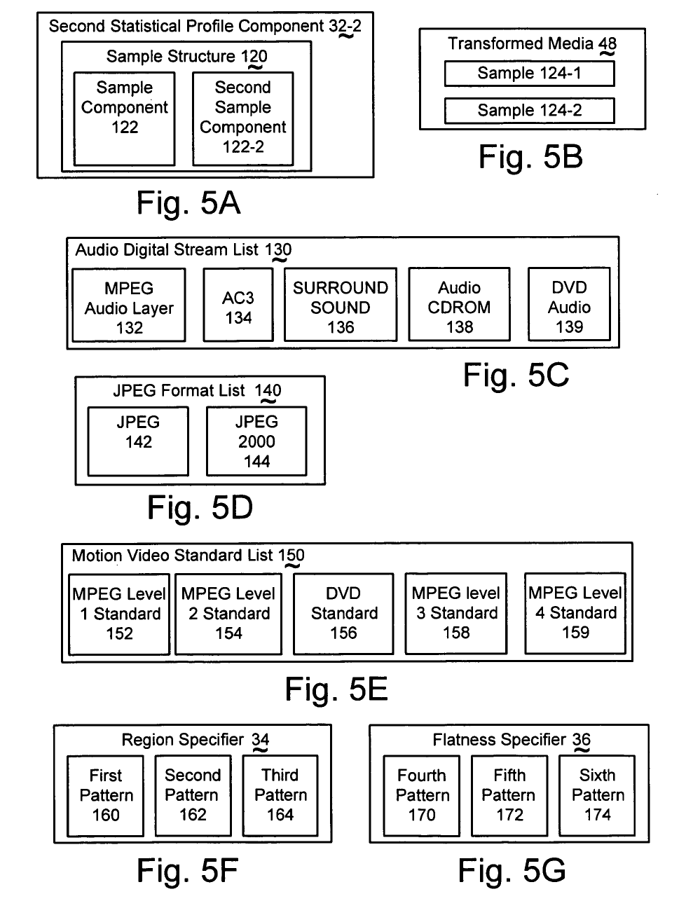

FIG. 5A shows the second statistical profile component 32-2 may further include a sample structure 120 comprising at least one sample component 122. Any statistical profile component 32 may include a sample structure 120. A sample structure 120 may also include more than two sample components. A statistical profile component may include more than one sample structure, for instance, it may contain one sample structure for luminance and a second sample structure for chrominance.

FIG. 5B shows the transformed media 48 of FIG. 3B may include at least two samples 124-1 and 124-2 of at least the sample component 122.

Examples of the sample structure 120 include the color planes of a JPEG media format supporting RGB, which include a Red, a Blue, and a Green sample component. JPEG media formats also support an 8 by 8 pixel DCT version of an 8 by 8 pixel array.

Other examples of the sample structure 120 involves an alternative JPEG media format including a luminance and two chrominance components, for three sample components. The 8 by 8 DCT version of the 8 by 8 luminance component array may be quantized, which coarsens the values in the 8 by 8 DCT luminance version. The resulting quantized, 8 by 8 DCT luminance component array may have as few as one non-trivial sample, although it typically has several. The resulting quantized DCT luminance samples for the two-dimensional content instance 2 of FIG. 3B, typically has a minimum of several hundred 8 by 8 DCT arrays, each with at least one non-trivial sample of the luminance sample component.

The media format 24 may include at least one digital stream of a one-dimensional content 102 as in FIG. 4F. The sample component 122 may preferably be a component of an amplitude sequence of the digital stream 102. Alternatively, the sample component may be a component of the power spectrum window of the digital stream 102. Further, the digital stream 102 may preferably be a version of an audio digital stream 130 as shown in FIG. 5C.

FIG. 5C shows the audio digital stream 130 may be compatible with any combination of the following: any version of any MPEG audio layer 132, any version of AC3 134, such as found in some versions of DVDs, SURROUND SOUND™ 136, and any version of an Audio CDROM format 138. By way of example, MPEG audio layers 132 refer to at least MPEG 1 Layers 1 to 3, any MPEG 2 audio formats, any MPEG 3 audio formats, and any MPEG 4 audio formats.

The media format 24 of FIG. 4F may include at least one instance of a two-dimensional content 104. The sample component 122 may preferably be a luminance component of the instance 104. Further, the instance 104 may preferably includes an expression compatible with at least one member of a JPEG format list 140, as shown in FIG. 5D. The JPEG format list 140 of FIG. 5D includes JPEG 142 and JPEG 2000, numbered 144.

The media format 24 of FIG. 4F may include at least one digital stream of a two-dimensional content 106. The sample component 122 may preferably be a luminance component of the digital stream 106. Further, the digital stream 106 may preferably includes an expression compatible is compatible with a version of at least one member of a motion video standard list 150, as shown in FIG. 5E.

The motion video standard list 150 of FIG. 5E includes an MPEG Level 1 standard 152, an MPEG Level 2 standard 154, a DVD standard 156, an MPEG level 3 standard 158, and an MPEG Level 4 standard 159.

FIG. 5F shows that the region specifier 34 of FIG. 1A may include at least one of a first predetermined pattern 160, a second predetermined pattern 162, and a third predetermined pattern 164.

FIG. 5G shows the flatness specificier 36 of FIG. 1A may include at least one of a fourth predetermined pattern 170, a fifth predetermined pattern 172, and a sixth predetermined pattern 174.

As used herein, a predetermined pattern such as 160, 162, or 164 will refer to a collection of samples, which may be searched to recognize a region. A predetermined pattern such as 170, 172 will refer to sample collections, which may be searched to discriminate which recognized regions are flat areas. The samples may be located in absolute terms, or relative terms. All patterns as used herein are finite collections, and preferably do not contain redundant references to the same sample location.

An example of a predetermined pattern of absolute sample locations, is a sequence of samples starting in the upper right hand corner of a two-dimensional instance, and proceeding clockwise around the perimeter of the instance.

An example of a predetermined pattern of relative sample locations, is a sequence in the DCT transform plane of an 8 by 8 pixel block of a JPEG image. The pattern may start at (0,0), the constant term, proceed through (1,0), and (0,1), and then stop. The pattern is relative, in that it does not specify which DCT block it applies to. A region may be recognized and have a pattern used by the flat area discriminator to determine that it contains a flat area.

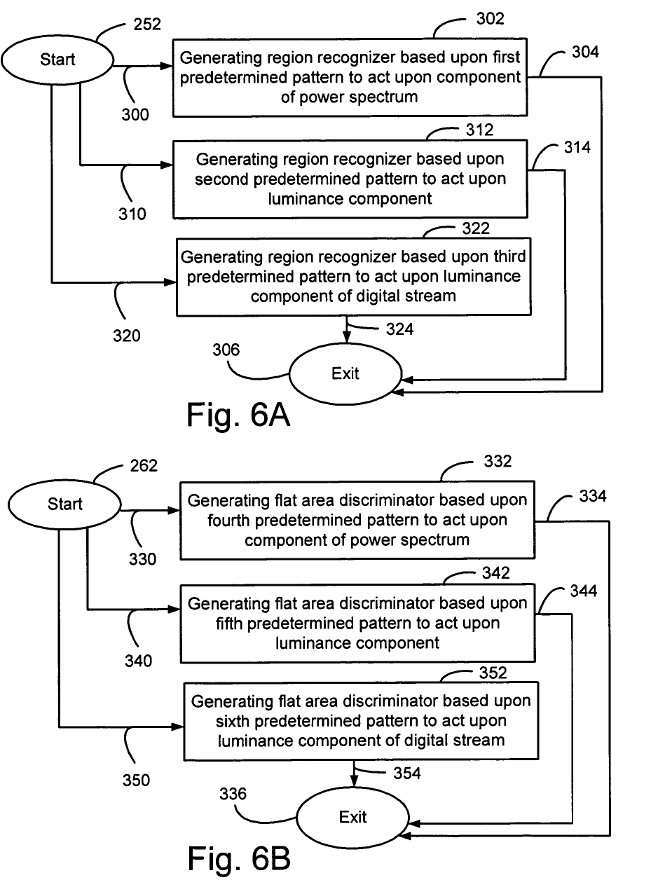

FIG. 6A shows a detail of operation 252 of FIG. 2A generating the region recognizer 42 of FIG. 1A preferably including at least one of the operations 302, 312, and/or 322.

FIG. 6B shows a detail of operation 262 of FIG. 2A generating the flat area discriminator 44 of FIG. 1A preferably including at least one of the operations 332, 342, and/or 352.

By way of example, the first predetermined pattern 160 of FIG. 5F may be associated with media format 24 including the digital stream of one-dimensional content 102 as shown in FIG. 4F. The fourth predetermined pattern 170 of FIG. 5G may be associated with media format 24 including the digital stream of one-dimensional content 102 as shown in FIG. 4F.

Operation 302, of FIG. 6A, supports generating the region recognizer 42 of FIG. 1A based upon the first predetermined pattern 160 of FIG. 5F, acting upon components of the amplitude sequences and/or the power spectrum 110 of FIG. 4F.

Operation 332, of FIG. 6B, supports generating the flat area discriminator 44 of FIG. 1A, based upon the fourth predetermined pattern 170 of FIG. 5G, acting upon components of the amplitude sequences and/or the power spectrum 110 of FIG. 4F.

By way of example, the second predetermined pattern 162 of FIG. 5F may be associated with media format 24 including the instance of two-dimensional content 104 as shown in FIG. 4F. The fifth predetermined pattern 172 of FIG. 5G may be associated with media format 24 including the instance of two-dimensional content 104 as shown in FIG. 4F.

Operation 312, of FIG. 6A, supports generating the region recognizer 42 of FIG. 1A based upon the second predetermined pattern 162 of FIG. 5F to act upon the luminance component 112 of FIG. 4F.

Operation 342, of FIG. 6B, supports generating the flat area discriminator 44 of FIG. 1A based upon the fifth predetermined pattern 172 of FIG. 5G to act upon the luminance component 112 of FIG. 4F.

By way of example, the third predetermined pattern 164 of FIG. 5F may be associated with media format 24 including the digital stream of two-dimensional content 106 as shown in FIG. 4F. The sixth predetermined pattern 174 of FIG. 5G may be associated with media format 24 including the digital stream of two-dimensional content 106 as shown in FIG. 4F.

Operation 322, of FIG. 6A, supports generating the region recognizer 42 of FIG. 1A based upon the third predetermined pattern 164 of FIG. 5F to act upon the luminance component 114 of the digital stream of FIG. 4F.

Operation 352, of FIG. 6B, supports generating the flat area discriminator 44 of FIG. 1A based upon the sixth predetermined pattern 174 of FIG. 5G to act upon the luminance component 114 of the digital stream of FIG. 4F.

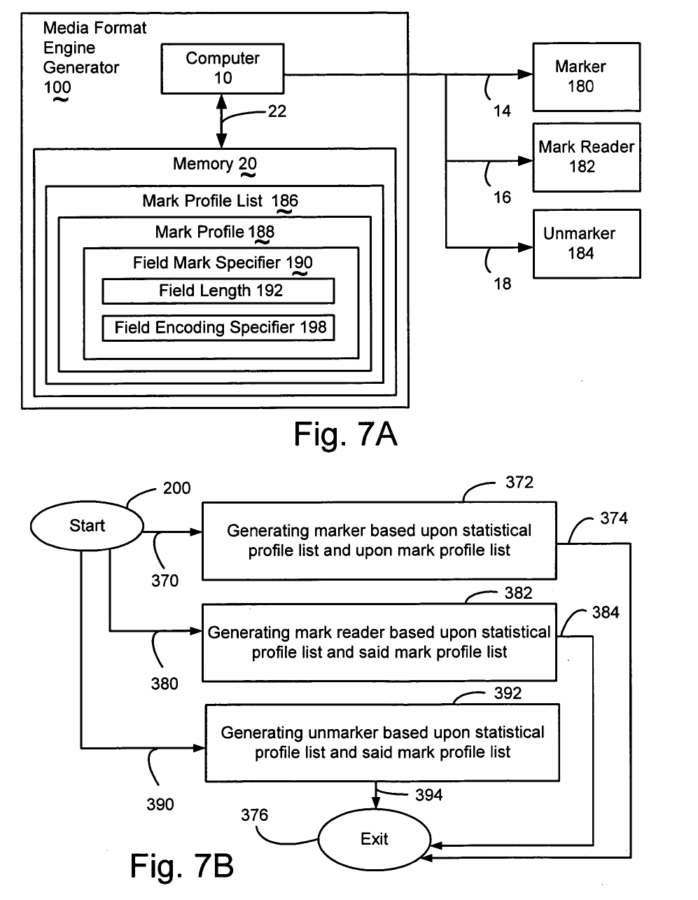

FIG. 7A shows the media format engine generator 100 of FIG. 1A further using a mark profile list 186 and further generating at least one of a marker 180, a mark reader 182, and an unmarker 184. The mark profile list 186 preferably resides in the memory 20 of FIG. 1A.

The mark profile list 186 of FIG. 7A includes at least one mark profile 188. It may be preferred that each of the mark profiles 188 comprises at least one field mark specifier 190. Each field mark specifier 190 may preferably include at least one field length 192 and a field encoding specifier 198.

FIG. 7B shows the program system 200 of FIG. 1A further implementing the method of the invention embodied in FIG. 7A.

In FIG. 7B, operation 372 supports generating 14 a marker 180 of FIG. 7A based upon the statistical profile list 30 of FIG. 1A and 2B and upon the mark profile list 186. Operation 382 supports generating 16 the mark reader 182 based upon the statistical profile list and upon the mark profile list 186. Operation 392 supports generating 18 the unmarker 184 based upon the statistical profile list 30 and upon the mark profile list 186.

Invention's method of generating media format engines so far includes the following. Acquiring 212 the statistical profile list 30 for the media format 24, as in FIGS. 1A and 1B. Generating 222 the media parser 40 based upon the statistical profile list 30, as in FIGS. 1A to 6B. And using at least one member of the marking generator group consisting of operations 372, 382, and 392 of FIG. 7B.

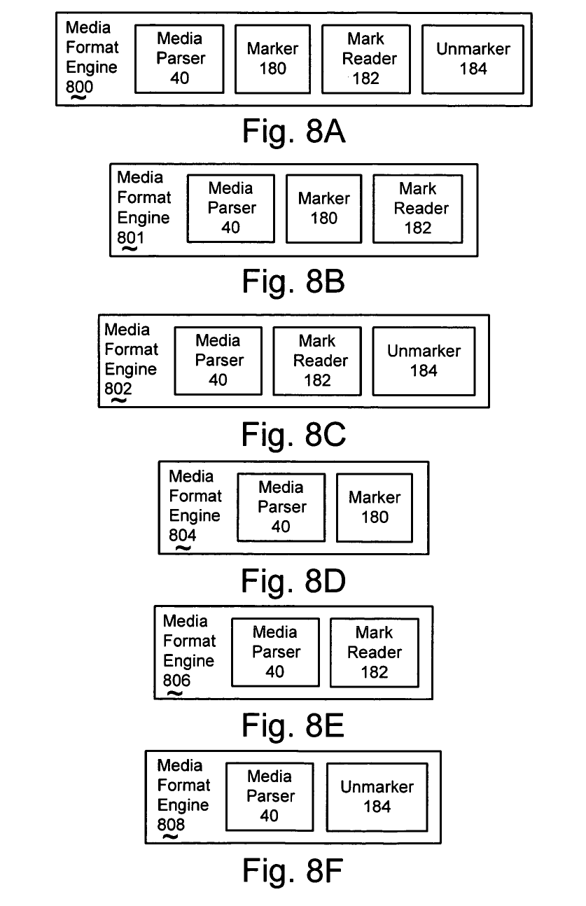

FIGS. 8A to 8F show various media format engines 800-808, which are products of the method.

FIGS. 8A to 8F show various media format engines 800-808, which are products of the method of FIGS. 1A-7B. These media format engines each contain the media processor 40, which is a product of the method as shown in FIGS. 1A to 6B. These media format engines also contain at least one instance of at least one of the following from FIG. 7A: the marker 180, the mark reader 182, and the unmarker 184.

The media format engine 800 of FIG. 8A includes at least one media parser 40 of FIGS. 1A and 3B, at least one marker 180 of FIG. 7A, at least mark reader 182, and at least one unmarker 184.

The media format engine 801 of FIG. 8B includes at least one media parser 40 of FIGS. 1A and 3B, at least one marker 180 of FIG. 7A, and at least mark reader 182.

The media format engine 802 of FIG. 8C includes at least one media parser 40 of FIGS. 1A and 3B, at least mark reader 182, and at least one unmarker 184.

The media format engine 806 of FIG. 8E includes at least one media parser 40 of FIGS. 1A and 3B, and at least mark reader 182 of FIG. 7A.

The media format engine 808 of FIG. 8F includes at least one media parser 40 of FIGS. 1A and 3B, and at least one unmarker 184.

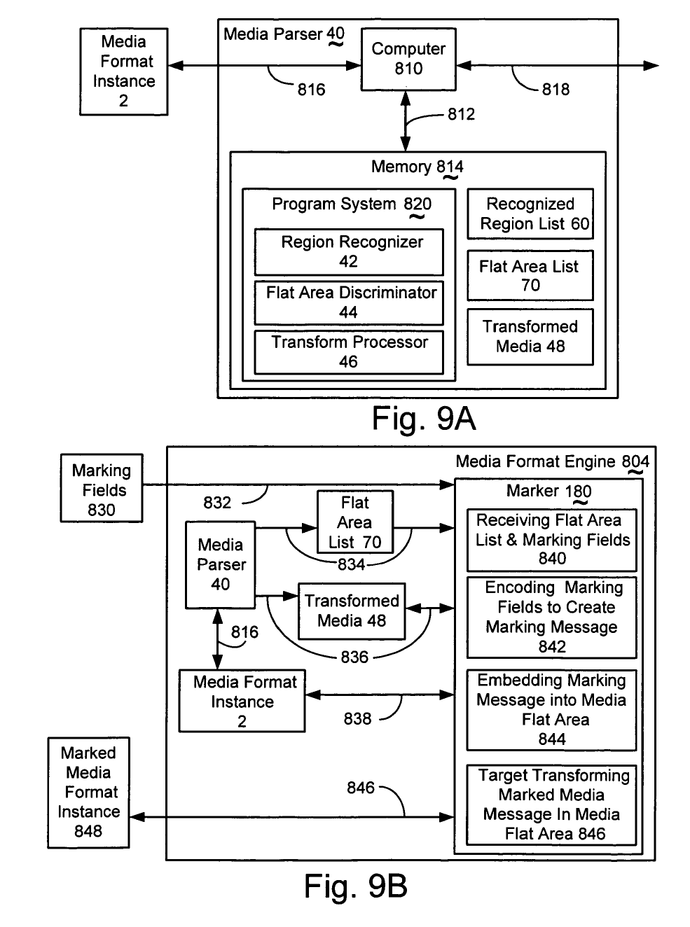

FIG. 9A shows an embodiment of the media parser 40 of FIGS. 1A and 3B, which may be sometimes preferred, including a second computer 810 accessing 812 a second memory 814, as well as accessing 816 the media format instance 2.

The second memory 814 of FIG. 9A contains a program system 820. The program system 820 controls the second computer 810.

The program system 820, at least partly, implements the region recognizer 42 of FIG. 1A and 3B, to create the recognized region list 60. The program system 820, at least partly, implements the flat area discriminator 44, which uses the recognized region list 60 to create the flat area list 70.

It may be further preferred that the program system 820, at least partly, implement the transform processor 46 of FIG. 3B. The transform processor 46 may act upon the accessed 816 media format instance 2 to, at least partly, create the transformed media 48.

The media format engine 804 of FIG. 8D includes at least one media parser 40 of FIGS. 1A and 3B, and at least one marker 180 of FIG. 7A.

FIG. 9B show refinements of the media format engine 804 of FIG. 8D, further showing the method of operation of the marker 180 of FIGS. 7A and 8D.

In FIG. 9B, the media format instance 2 of FIGS. 3B and 9A, is accessed 816 by the media parser 40 of FIGS. 1A, 3B, and 9A. The media parser 40 provides 834 the flat area list 70 to the marker 180.

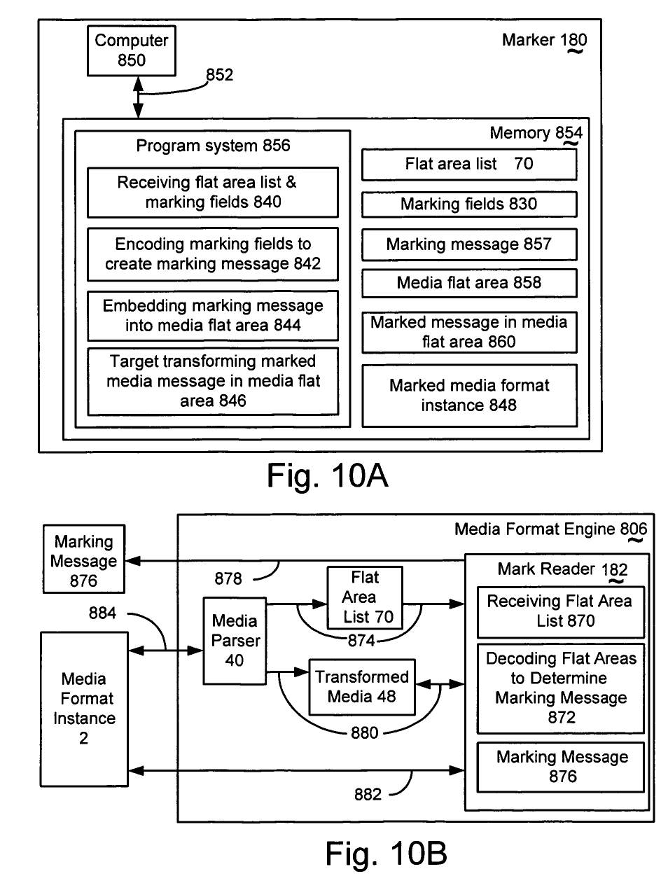

FIG. 10A shows a refinement of the marker 180 of FIGS. 7A, 8A, 8B, 8D, and 9B implementing its method of operation using a third computer 850 accessing 852 a third memory 854. The third memory 854 includes a program system 856, the flat area list 70 of FIGS. 3B and 9B, marking field 830, marking message 857, media flat area 860, and the marked media format instance 848 of FIG. 9B.

In FIGS. 9B and 10A, the marker 180 operates as follows. The flat area list 70 and marking fields 830 are received 840. The receiving 840 may be implemented by a program system 856 as shown in FIG. 10A. The marking fields 830 may be provided 832 to the marker 180 as shown in FIG. 9B. The marking fields 830 are encoded 842 to create a marking message 857. The marking message 857 is embedded 844 into a media flat area 860.

The media flat area 858 of FIG. 10A is based upon the flat area list 70 and a form of access of the media format instance 2 of FIG. 9B. There are two preferred forms of access. Access 838 to the media format instance 2. And access 836 to a transformed media 48, based upon the media format instance 2, to which the transform processor 46 of FIGS. 3B and 9A has been applied. The access 838 may either be a direct access as shown in FIG. 9B, or may alternatively involve access through the media parser 40, which is not shown.

In FIGS. 9B and 10A, the marker 180 may further include means 846 for target transforming the marked media message in the media flat area 860 to, at least partly, create the marked media format 848. The means 846 may be implemented as at least one program step included in the program system 856 of FIG. 10A.

The means 840, 842, 844, and optionally, 846 of FIG. 9B, may be implemented to contain at least one third computer 850 as shown in FIG. 10A. Alternatively the means 840-846 may be implemented containing multiple computers. The means 840-846 may each be further implemented containing a computer.

FIG. 10B shows some details of the media format engine 806 of FIG. 8E, further showing the interaction of the media parser 40 and the mark reader 182.

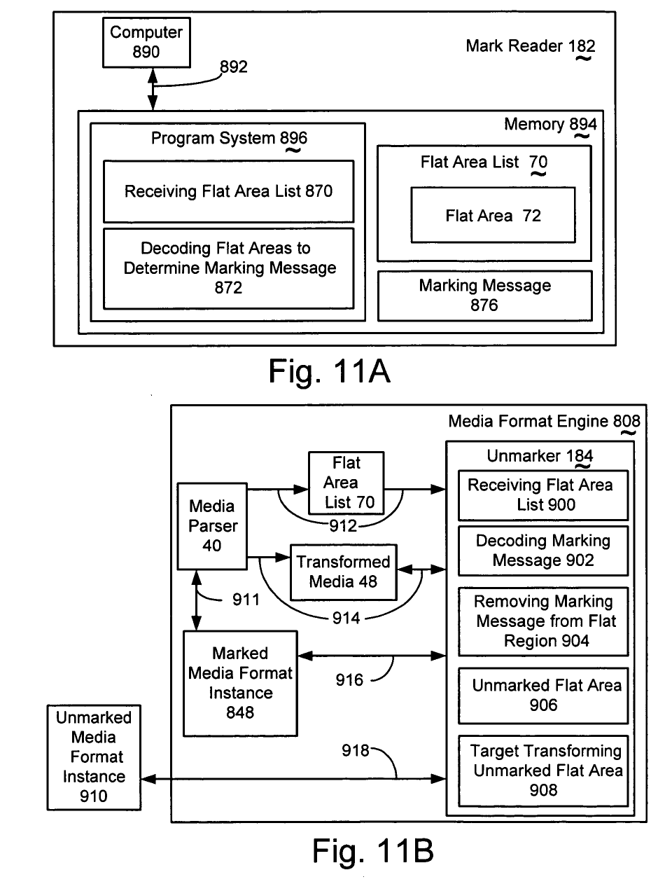

FIG. 11A shows a refinement of the mark reader 182 of FIGS. 7A, 8A, 8B, 8C, 8E, and 10B implementing its method of operation using a fourth computer 890 accessing 892 a fourth memory 894. The fourth memory 894 includes a program system 896, the flat area list 70 of FIGS. 3B, 9B, and 10A, the marking message 876 of FIGS. 10A and 10B.

In FIGS. 10B and 11A, the mark reader 182 operates as follows. The flat area list 70 is received 870. In FIG. 10B, the flat area list 70 is received 870 from 874 the media parser 40. The flat area list 70 may be received 870 across a network 874 coupled with the media parser 40. Decoding 872 at least one of the flat areas determines the marking message 876. The flat area list 70 includes the flat area 72, as shown in FIGS. 3B and 11A. FIG. 10B further shows the marking message 876 being sent 878 outside the media format engine 806.

In FIG. 10B, the media format engine 806 may further include the media parser 40 prividing the transformed media 48 for access 880 by the mark reader 182.

FIG. 11B shows some details of the media format engine 808 of FIG. 8F, which includes the media parser 40 of FIGS. 1A, 3B, and 9A, interacting with the unmarker 184 of FIGS. 7A, 8A, 8C, and 8F.

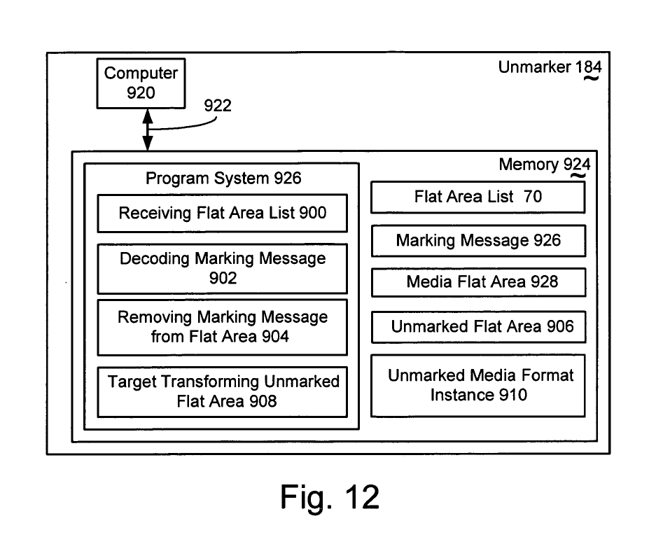

FIG. 12 shows a refinement of the unmarker 184 of FIGS. 7A, 8A, 8C, 8F, and 11B implementing its method of operation using a fifth computer 920 accessing 922 a fifth memory 924. The fifth memory 924 includes a program system 926, the flat area list 70 of FIGS. 3B, 9B, and 10A, the marking message 926, the media flat area 928, the unmarked flat area 906 and the unmarked media format instance 910.

In FIGS. 11B and 12, the unmarker 184 operates as follows. The flat area list 70 is received 900. The marking message 926 is decoded 902, based upon the received flat area list 70. The media flat area 928 may preferably be determined based upon the flat area list 70. The marking message 926 is removed 904 from the media flat area 928 to, at least partly, create the unmarked flat area 906. The unmarked flat area 906 is used to, at least partly, create the unmarked media format instance 910. It may be preferred that a target transform 908 acts upon the unmarked flat area 906 to further, at least partly, create the unmarked media format instance 910.

In FIG. 12, the method is shown implemented, at least partly, by a program system 926 residing in the fifth memory 924.

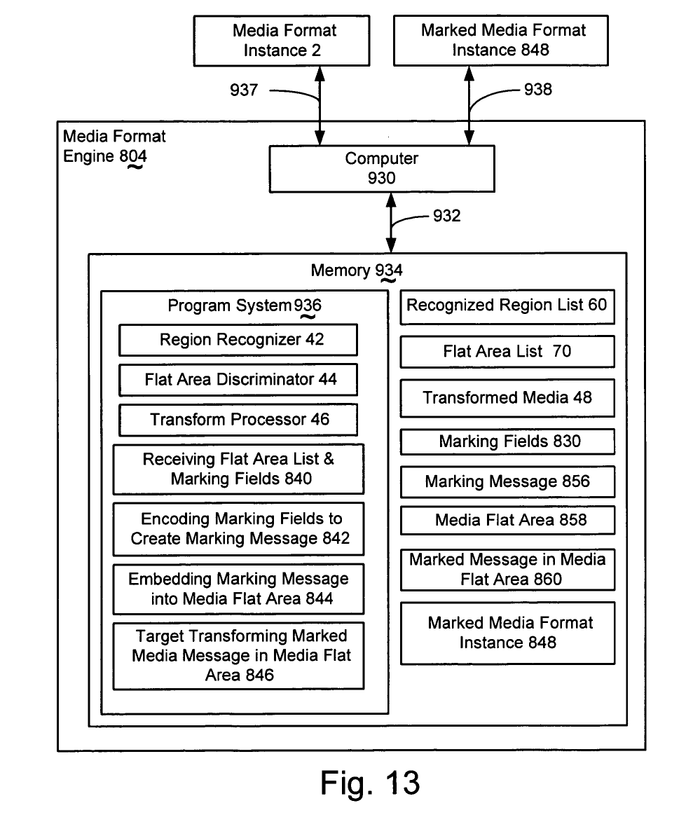

FIG. 13 shows details an alternative media format engine 804 of FIG. 8D, 9B and 10A, with both the operating methods of the media parser 40 and the marker 180 implemented in a single program system 936. The program system 936 resides in a sixth memory 934, which is accessibly coupled to a sixth computer 930. The sixth computer 930 accesses 937 the media format instance 2, of FIGS. 3B, 9B, and 10A. The sixth computer 930 creates 938 the marked media format instance 938 through the sixth computer 930, directed by the program system 936.

The operation of the specific steps of the method embodied in program system 936 of FIG. 13 includes the operations 42, 44, and optionally, 46, as discussed above with regards to the operation of the media parser 40. The operation 42 of the region recognizer provides the recognized region list 60. The operation 44 of the flat area discriminator provides the flat area list 70. The operation 46 of the transform processor provides the transformed media 48.

The operation of the specific steps of the method embodied in program system 936 of FIG. 13 further includes the operations 840, 842, 844, and optionally, 846, as discussed above with regards to the operation of the marker 180. The flat area list 70 and at least one of the marking fields 830 are received 840. The marking field(s) 830 are encoded 842 to create the marking message 857. The marking message 857 is embedded 844 into the media flat area 858 to create the marked message in the flat area 860, which at least partly creates the marked media format instance 848. The method may further include target transforming the marked media message in the media flat area 860 to create the marked media format instance 848.

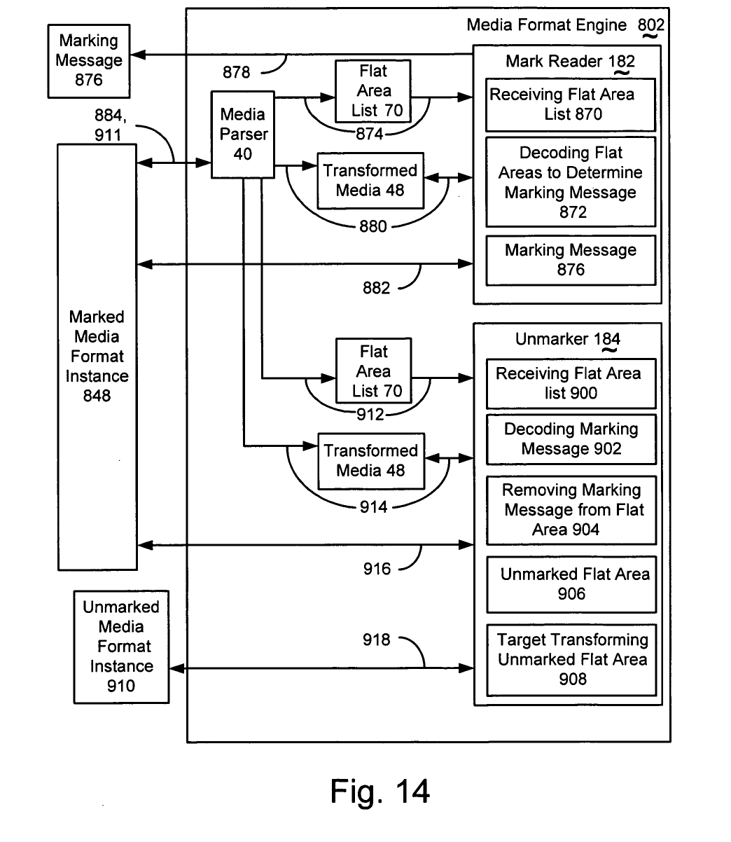

FIG. 14 shows some of the details of the media format engine 802 of FIG. 8C, which includes the operations and functional elements of the media parser 40 interacting with the mark reader 182 and the unmarker 184. The media format engine 802 creates the marking message 876 and the unmarked media format instance 910, from the marked media format instance 848. The media parser 40, the mark reader 182 and the unmarker 184 operate as previously stated.

It should be noted that the media parser 40, with any combination of the marker 180, the mark reader 182, and the unmarker 184 may be implemented on a single computer. The method of operating such a computer is a similar to the operations shown in the preceding Figures.

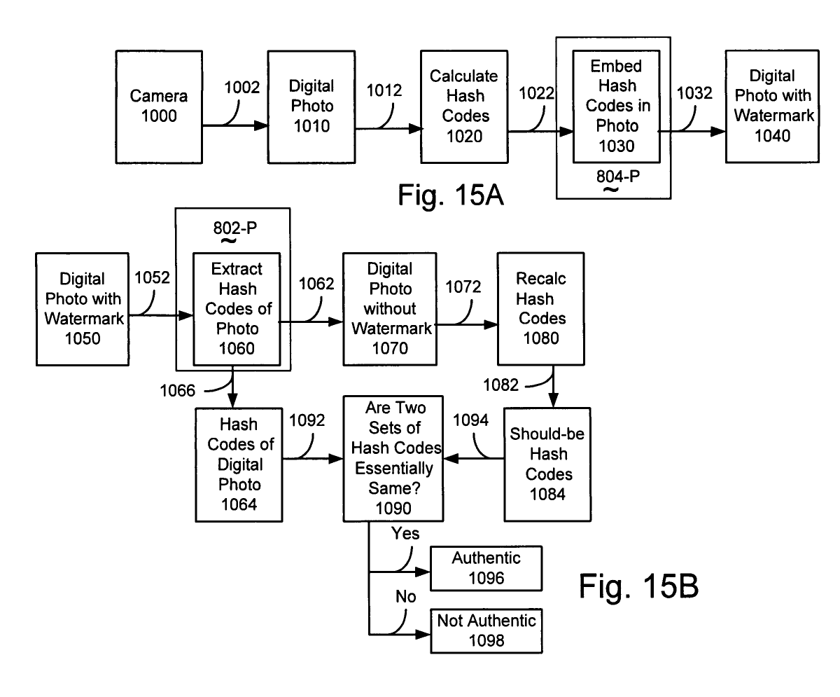

FIGS. 15A, 16A, 17A, 18A, 19A, 20A, and 21A to 24, show the use of various embodiments of the media format engine 804, for use with specific media formats 24.

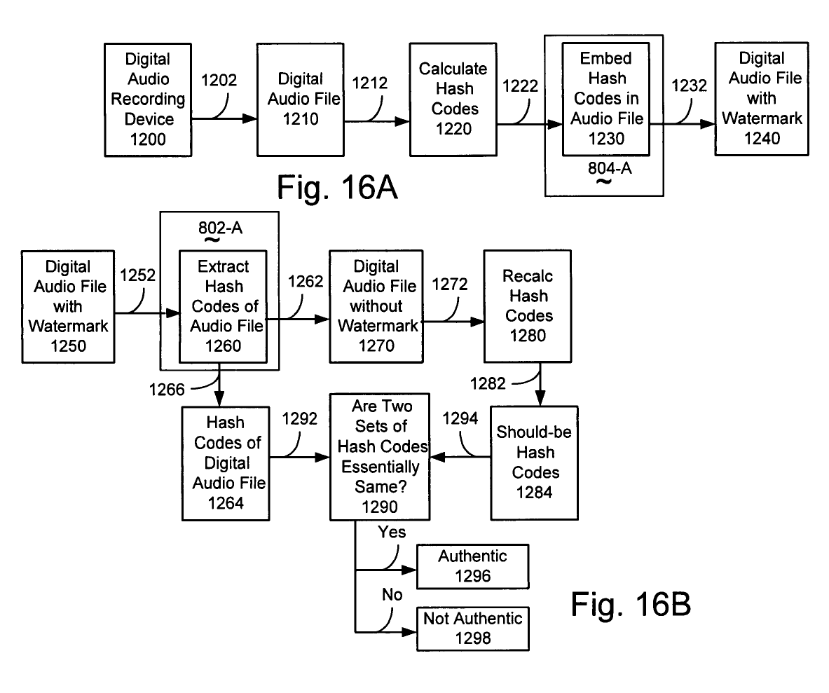

FIGS. 16A, 19A, 22A to 22C, and 24, show the use of various embodiments of the media format engine 804-A, for use with the media formats 24 including a digital stream of the one-dimensional content 102. The one-dimensional digital stream may be compatible with at least one member of the audio digital stream list 130 of FIG. 5C.

In FIG. 16A, the media format engine 804-A is used to embed an audio hash code 1230 into the digital audio file 1210, as the media format instance 2, of the FIGS. 9B and 13. The media format engine 804-A, creates the digital audio file with a watermark 1240 as a marked media format instance 848. An audio hash code calculator 1220 creates 1222 the audio hash code 1230.

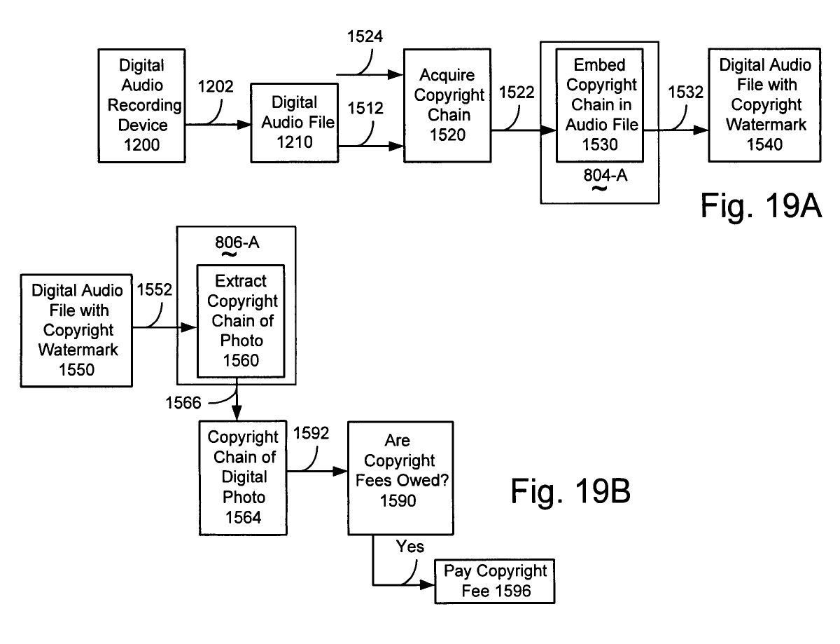

In FIG. 19A, the media format engine 804-A is used to embed a copyright chain 1530 into the digital audio file 1210, as the media format instance 2, of the FIGS. 9B and 13. The media format engine 804-A, creates the digital audio file with a copyright watermark 1540 as a marked media format instance 848.

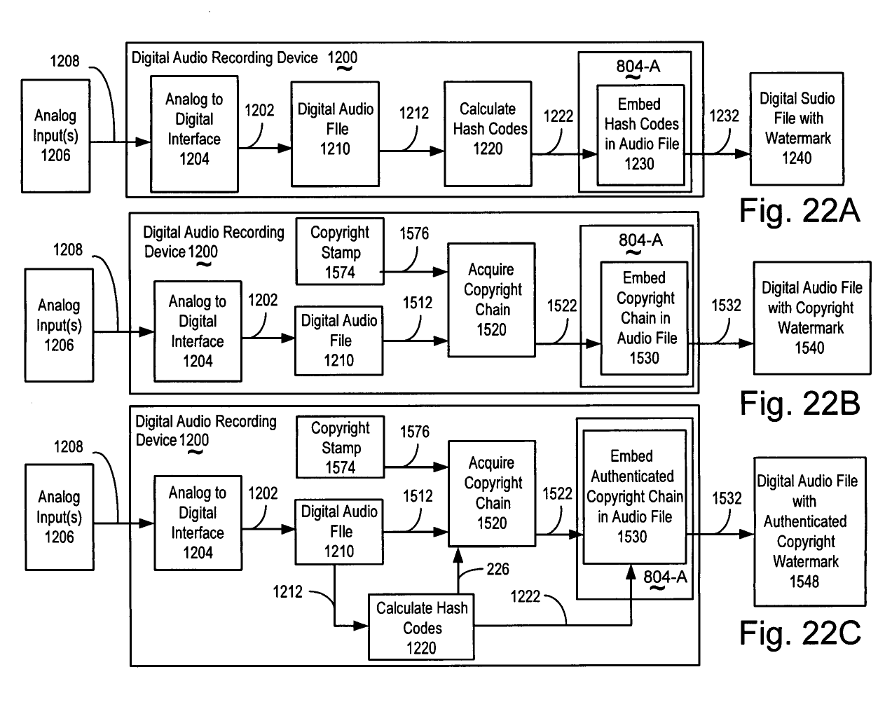

In FIG. 22A, the media format engine 804-A of FIG. 16A is included in the digital audio recording device 1200.

In FIG. 22B, the media format engine 804-A of FIG. 19A is included in the digital audio recording device 1200.

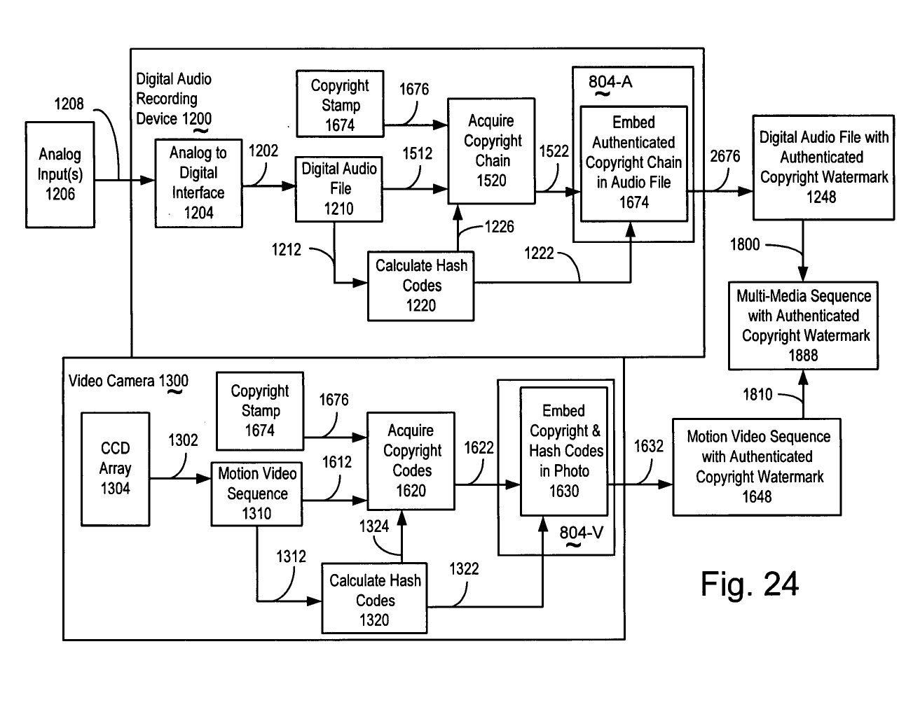

In FIGS. 22C and 24, the media format engine 804-A is also included in the digital audio recording device 1200. The media format engine 804-A creates a digital audio file with an authenticated copyright watermark 1548, using the hash codes of FIGS. 16A and 22A to authenticate the copyright chains of FIGS. 19A and 22B.

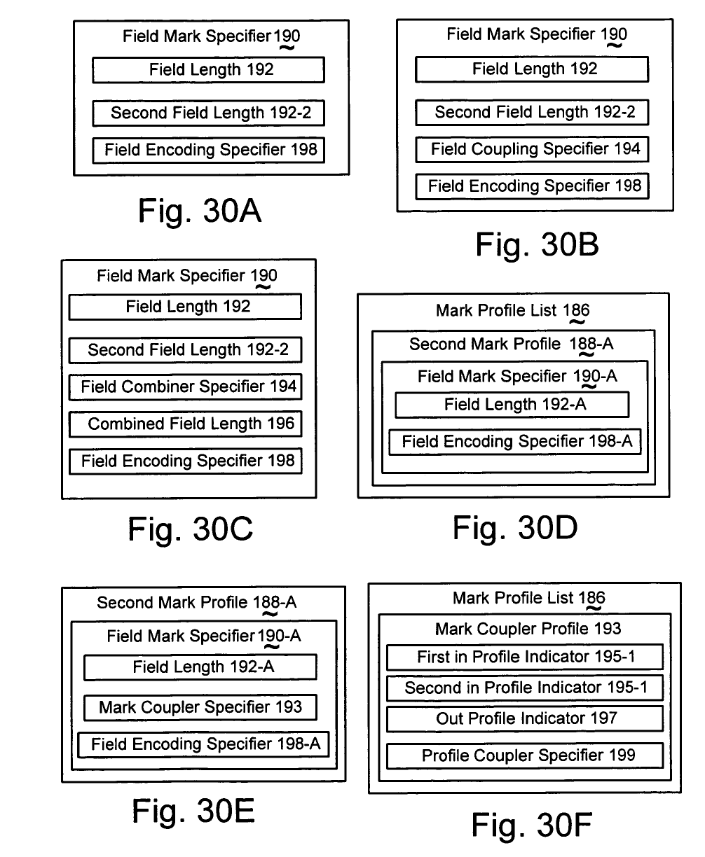

The media format engine 804-A of FIGS. 22C and 24, is preferably the product of the process of FIG. 7A, 7B, using one of the various mark profile collection alternatives shown in FIGS. 30A to 30F.

FIGS. 15A, 18A, and 21A to 21C, show the use of various embodiments of the media format engine 804, for use with the media formats 24 including an instance of the two-dimensional content 104. The two-dimensional instance may be compatible with at least one member of the JPEG list 140 of FIG. 5D.

In FIG. 15A, the media format engine 804-P is used to embed a hash code 1030 into a digital photo 1010, as the media format instance 2, of the FIGS. 9B and 13. The media format engine 804-P, creates the digital photo with a watermark 1040 as a marked media format instance 848. The 2-D hash code calculator 1020 creates 1022 the hash code 1030.

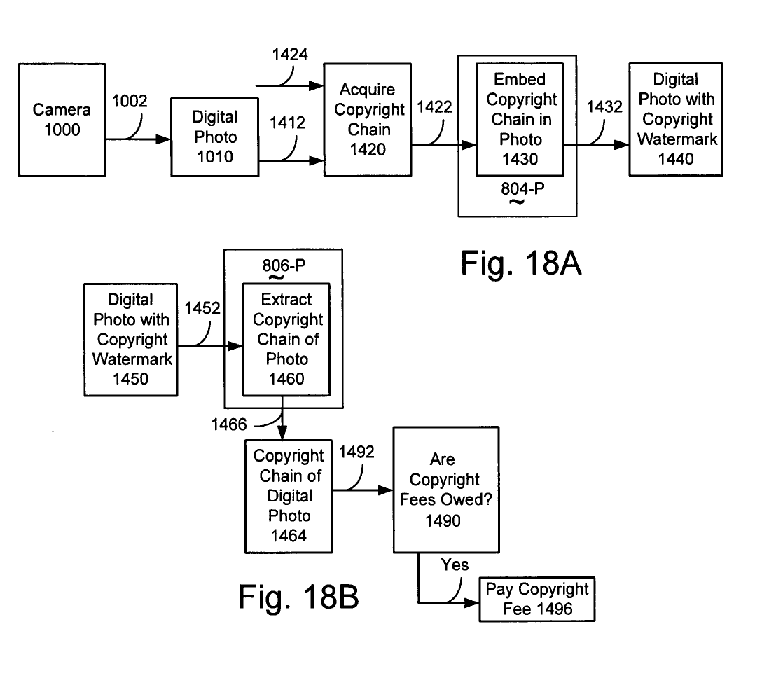

In FIG. 18A, the media format engine 804-P is used to embed a copyright chain 1430 into the digital photo 1010, as the media format instance 2, of the FIGS. 9B and 13. The media format engine 804-P, creates the digital photo with a copyright watermark 1440 as a marked media format instance 848.

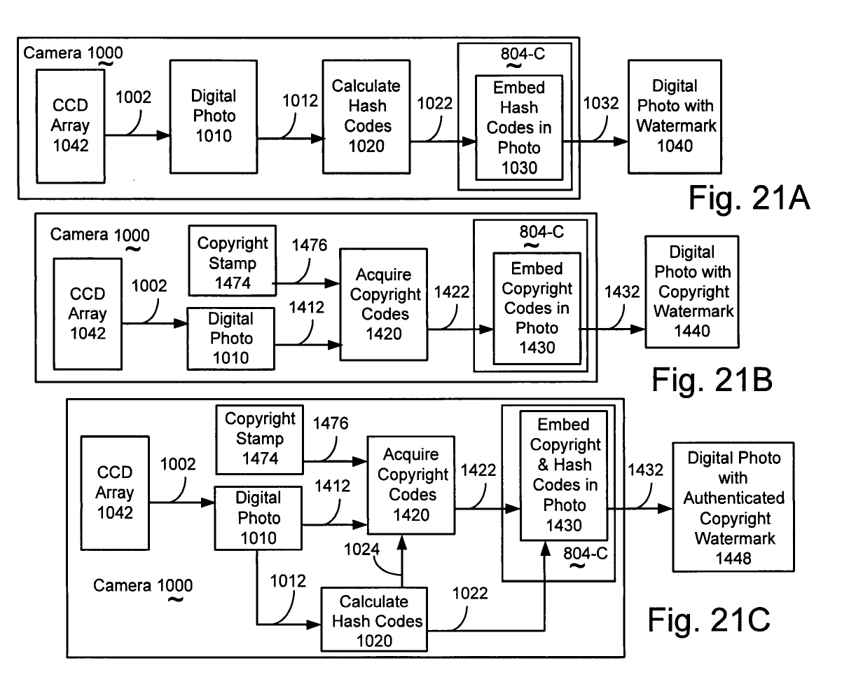

In FIG. 21A, the media format engine 804-P of FIG. 16A is included in the digital camera 1000.

In FIG. 21B, the media format engine 804-P of FIG. 19A is included in the digital camera 1000. The media format engine 804-P embeds the copyright stamp 1474 as acquired 1420 to create the digital photo with a copyright watermark 1440.

In FIG. 21C, the media format engine 804-P is also included in the digital camera 1000. The media format engine 804-A creates a digital photo with an authenticated copyright watermark 1448, using the hash codes of FIGS. 15A and 21A to authenticate the copyright stamps of FIGS. 18A and 21B.

The media format engine 804-A of FIG. 21C, is preferably the product of the process of FIG. 7A, 7B, using one of the various mark profile collection alternatives shown in FIGS. 30A to 30F.

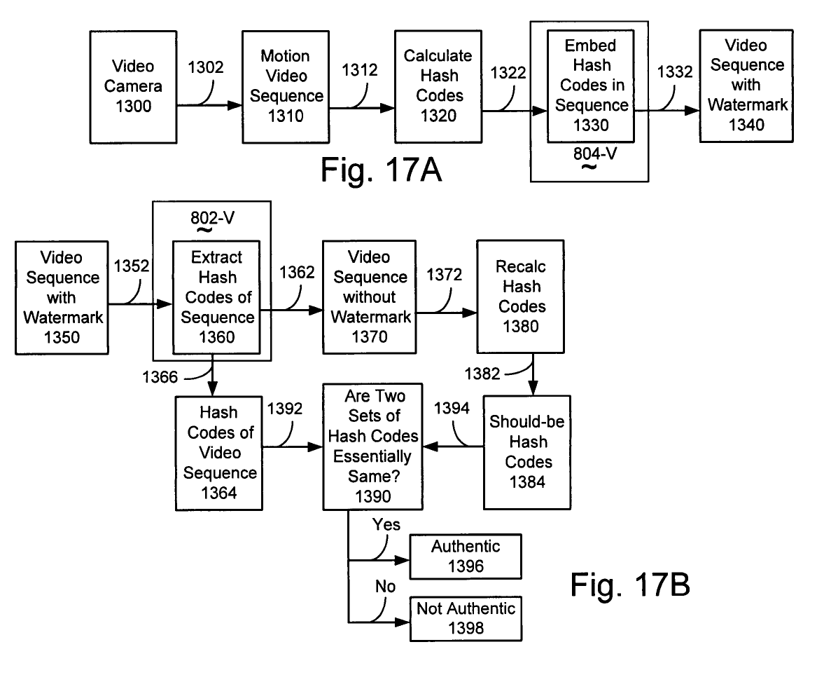

FIGS. 17A, 20A, and 23A to 24, show the use of various embodiments of the media format engine 804, for use with the media formats 24 including a digital stream of two-dimensional content 106. The two-dimensional digital stream may be compatible with at least one member of the MPEG video standard list 150 of FIG. 5E.

In FIG. 17A, the media format engine 804-V is used to embed a video hash code 1330 into the motion video sequence 1310, as the media format instance 2, of the FIGS. 9B and 13. The media format engine 804-V, creates the video sequence with a watermark 1340 as a marked media format instance 848. A video hash code calculator 1320 creates 1322 the video hash code 1330.

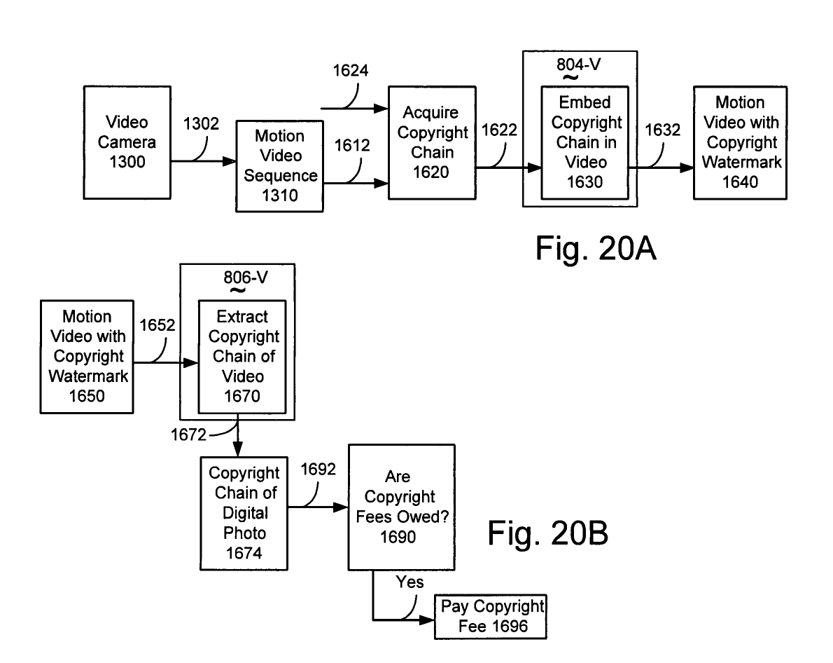

In FIG. 20A, the media format engine 804-V is used to embed a copyright chain 1530 into the motion video sequence 1310, as the media format instance 2, of the FIGS. 9B and 13. The media format engine 804-V, creates the video sequence with a copyright watermark 1640 as a marked media format instance 848.

Figures and 23A to 24, show the use of various embodiments of the media format engine 804, for use with the media formats 24 including a digital stream of two-dimensional content 106. The two-dimensional digital stream may be compatible with at least one member of the MPEG video standard list 150 of FIG. 5E.

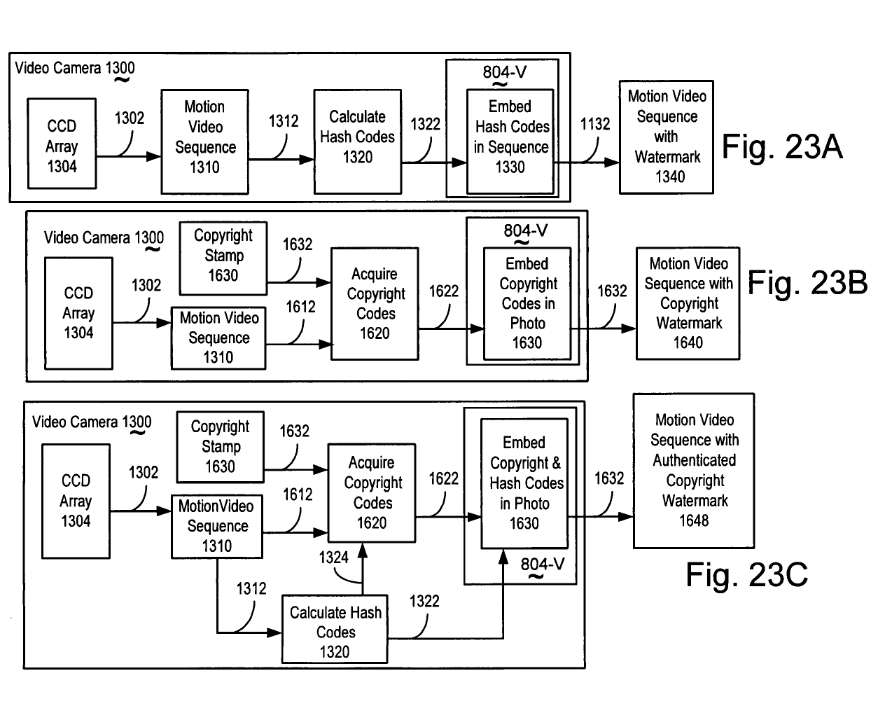

In FIG. 23A, the media format engine 804-V of FIG. 17A is included in the video camera 1300.

In FIG. 23B, the media format engine 804-V of FIG. 20A is included in the video camera 1300.

In FIGS. 23C and 24, the media format engine 804-V is also included in the video camera 1300. The media format engine 804-V creates a motion video sequence with an authenticated copyright watermark 1648, using the hash codes of FIGS. 17A and 23A to authenticate the copyright stamps 1630 acquired 1620, as in FIGS. 19A and 22B.

The media format engine 804-V of FIGS. 23C and 24, is preferably the product of the process of FIGS. 7A and 7B, using one of the various mark profile collection alternatives shown in FIGS. 30A to 30F.

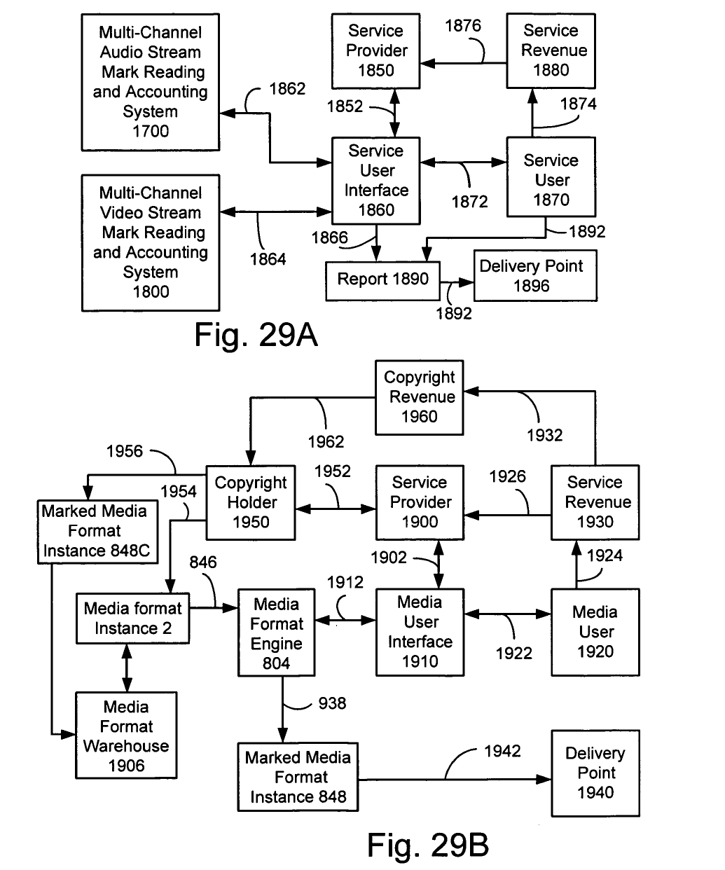

FIG. 29B shows using a media format engine 804 to provide copyright services for a copyright holder 1950 and a media user 1920. The system and method generates a service revenue 1930 for the system service provider 1900 and copyright revenue 1960 for the copyright holder 1950. The media format engine 804 has been previously discussed in FIGS. 8D, 9B, 10A, 13, 15A, 16A, 17A, 18A, 19A, 20A, 21A to 24, and 26A to 27B.

In FIG. 29B, the media format engine 804 may include at least one media parser 40 capable of processing more than one media format 24 as shown in FIGS. 4F, 5C, 5D, and 5E. The media formats 24 may involve more than one kind of content 102, 104, and 106 as shown in FIG. 4F.

In FIG. 29B, the media format engine 804 may further include any combination of the mark reader 182 and/or the unmarker 184, as shown in FIGS. 7A, 8A, 8B, 10B to 12, 14, 15B, 16B, 17B, 18B, 19B, 20B, 28A, and/or 28B.

FIG. 15B shows using the media format engine 802-P of FIGS. 8C and 14, on a marked media format instance 848 as a digital photo with watermark 1050. The media format engine 802-P extracts the unmarked media instance 910 of FIG. 14, as the digital photo without watermark 1070. The media format engine 802-P also extracts the marking message 876 of FIG. 14, as the hash codes of the digital photo 1064. The hash codes are recalculated 1080 using 1072 the digital photo without watermark 1070 to create 1082 the should-be hash codes 1084.

In FIG. 15B, the hash codes of the digital photo 1064 are compared 1090 to the should-be hash codes 1084. One or both of the hash codes 1064 and 1084 may include error correction codes and/or other cryptographic mechanisms, so that two essentially the same hash codes may not be identical, until these mechanisms are taken into account. If the hash codes are essentially the same, then the digital photo with watermark 1050 is authentic 1096. If the hash codes are not essentially the same, then the digital photo with watermark 1050 is not authentic 1096.

FIG. 16B shows using the media format engine 802-A of FIGS. 8C and 14, on a marked media format instance 848 as a digital audio file with watermark 1250. The media format engine 802-A extracts the unmarked media instance 910 of FIG. 14, as the digital audio file without watermark 1270. The media format engine 802-A also extracts the marking message 876 of FIG. 14, as the hash codes of the digital audio file 1264. The hash codes are recalculated 1280 using 1272 the digital audio file without watermark 1270 to create 1282 the should-be hash codes 1284.

In FIG. 16B, the hash codes of the digital audio file 1264 are compared 1290 to the should-be hash codes 1284. One or both of the hash codes 1264 and 1284 may include error correction codes and/or other cryptographic mechanisms, so that two essentially the same hash codes may not be identical, until these mechanisms are taken into account. If the hash codes are essentially the same, then the digital audio file with watermark 1250 is authentic 1296. If the hash codes are not essentially the same, then the digital audio file with watermark 1250 is not authentic 1296.

FIG. 17B shows using the media format engine 802-V of FIGS. 8C and 14, on a marked media format instance 848 as a video sequence with watermark 1350. The media format engine 802-V extracts the unmarked media instance 910 of FIG. 14, as the video sequence without watermark 1370. The media format engine 802-V also extracts the marking message 876 of FIG. 14, as the hash codes of the video sequence 1364. The hash codes are recalculated 1380 using 1372 the video sequence without watermark 1370 to create 1382 the should-be hash codes 1384.

In FIG. 17B, the hash codes of the video sequence 1364 are compared 1390 to the should-be hash codes 1384. One or both of the hash codes 1364 and 1384 may include error correction codes and/or other cryptographic mechanisms, so that two essentially the same hash codes may not be identical, until these mechanisms are taken into account. If the hash codes are essentially the same, then the video sequence with watermark 1350 is authentic 1396. If the hash codes are not essentially the same, then the video sequence with watermark 1350 is not authentic 1396.

FIG. 18B shows using the media format engine 806-P of FIGS. 8E, 10B and 11A, on a marked media format instance 848 as a digital photo with a copyright watermark 1450. The media format engine 806-P extracts 1466 the marking message 876 of FIG. 14, as the copyright chain of the digital photo 1464. The copyright chain 1464 is examined 1492 to determine whether 1490 copyright fees are owed. If copyright fees are owed, then payment of the copyright fee 1496 is initiated.

FIG. 19B shows using the media format engine 806-A of FIGS. 8E, 10B and 11A, on a marked media format instance 848 as a digital audio file with a copyright watermark 1550. The media format engine 806-A extracts 1566 the marking message 876 of FIG. 14, as the copyright chain of the digital audio file 1564. The copyright chain 1564 is examined 1592 to determine whether 1590 copyright fees are owed. If copyright fees are owed, then payment of the copyright fee 1596 is initiated.

FIG. 20B shows using the media format engine 806-V of FIGS. 8E, 10B and 11A, on a marked media format instance 848 as a motion video with a copyright watermark 1650. The media format engine 806-V extracts 1672 the marking message 876 of FIG. 14, as the copyright chain of the digital photo 1674. The copyright chain 1674 is examined 1692 to determine whether 1690 copyright fees are owed. If copyright fees are owed, then payment of the copyright fee 1696 is initiated.

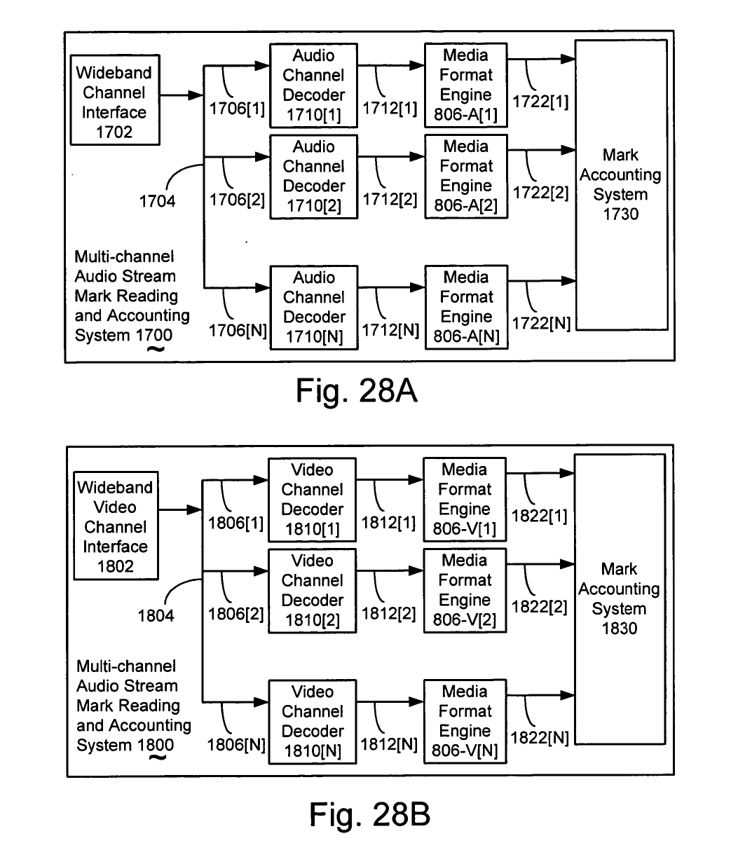

FIG. 28A shows a multiple channel audio stream mark reading and accounting system 1700 using the media format engines 806-A of FIGS. 8E, 10B and 11A.

In FIG. 28A, the system 1700 uses more than one media format engine 806-A[I] of FIGS. 8E, 10B and 11A, for 1 from 1 to N, where N is at least two, and in the Figure, at least 3. Each media format engine 806-A[I] receives 1712[I] a marked media format instance 848[I], which is not shown, from audio channel decoder 1710[I]. Each of the media format engines 806-A[I] extracts the marking message 876 of FIG. 14, which is sent 1722[I] to the mark accounting system 1730. Each of the audio channel decoders 1710[I] receives 1706[I] a distributed wideband audio signal 1704 from at least one wideband audio channel interface 1702.

In FIG. 28B, the system 1800 uses more than one media format engine 806-V[I] of FIGS. 8E, 10B and 11A, for 1 from 1 to N, where N is at least two, and in the Figure, at least 3. Each media format engine 806-V[I] receives 1812[I] a marked media format instance 848[I], which is not shown, from video channel decoder 1810[I]. Each of the media format engines 806-V[I] extracts the marking message 876 of FIG. 14, which is sent 1822[I] to the mark accounting system 1830. Each of the video channel decoders 1810[I] receives 1806[I] a distributed wideband video signal 1804 from at least one wideband video channel interface 1802.

In FIGS. 28A and 28B, the wideband channel interfaces 1702 and 1802 may connect to one or more of the following: wireless broadcast interfaces such as radio, television, and/or satellite antenna interfaces, wireline broadcast interfaces including, but not limited to residential broadband networks, the internet, a version of ethernet, and cable television distribution networks. Cable television may include standard channels, and/or pay for view channels and/or video on demand channels.

FIG. 29A shows a business method and system using at least one of the systems 1700 of FIG. 28A and/or the systems 1800 of FIG. 28B. A service user 1870 interacts with a service user interface 1860, which in turn communicates with the systems 1700 and/or 1800. The service user 1870 may send 1872 a request 1876 for generating 1866 a report 1890. The report 1890 may include documenting the appearance of a given marking message 876 of FIGS. 10B and 11A as found by at least one of the systems 1700 and/or 1800. The report 1890 is sent 1892 to the service user 1870, and/or may be received 1894 at another delivery point 1896.

The system shown in FIG. 29A, including the service user interface 1860, systems 1700 and/or 1800, carries out the request 1874 based upon a commitment by the service user 1870. The service user 1870 commits to providing 1874 a service revenue 1880 to 1882 to at least one service provider 1850. The service provider 1850 owns and/or manages and/or maintains at least one of the following. The service user interface 1860, and/or at least one of the systems 1700 of FIG. 28A and/or at least one of the systems 1800 of FIG. 28B.

The report 1890 of FIG. 29A may document the appearance of any marking message indicating a copyright watermark. The report 1890 may document the appearance of specific marking messages indicating a commercial advertisement for a specific company, and/or product, and/or service. The report 1890 may include documented appearances for a specific channel [I], and/or for a specific time period. By way of example, an advertiser may wish to know whether a particular advertisement played on a specific channel, when was it played, and how often, over the period the channel provider agreed to. If the channel provider did not fulfill the agreement, the advertiser can seek compensation for a breach of the advertising agreement.

FIG. 29B shows a business method using at least one media format engine 804 of FIGS. 8D, 9B, 10A, and 13 to provide 938 the marked media format instance 848. The media user 1920 interacts 1922 with the media user interface 1910 to request the marked media format instance 848 be sent 1942 to a delivery point 1940, which may or may not be the media user 1920.

The activities of the media format engine 804 of FIG. 29B are initiated 1912 by the media user interface 1910 when the media user 1920 commits to provide 1924 a service revenue 1930. The service revenue 1930 is at least partly received 1926 by a service provider 1900. The service provider 1900 owns and/or manages and/or maintains at least one of the following. The media user interface 1910, the media format engine 804 and/or the media format warehouse 1906 and/or the delivery 1942 of the marked media format instance 848 to the delivery point 1940.

The copyright holder 1950 of FIG. 29B may provide 1954 the media format instance 2, or alternatively, provide 1956 a marked media format instance 848C to the media format warehouse 1906. The marked media format instance 848C may contain a copyright watermark and/or an authenticated copyright watermark as discussed for various media formats in the preceding Figures. The media format engine 804 preferably treats the provided instance as if it was the media format instance 2, which is why the Figure is so drawn. The media format warehouse 1906 provides the media format instance 2 to the media format engine 804 based upon the commitment of service revenue 1930 for the request of from 1922 the media user 1920.

The business method of FIG. 29B may further include direct communication between the media format warehouse 1906 and/or the media user interface and/or the service provider 1900.

The marking message in the marked media format instance 848C of FIG. 29B may preferably be generated by a separate media format engine 800, 801, and/or 804. The preferably separate media format engine may be built using a different encoding specifier and/or flat area specifier, as discussed in the earlier Figures.

The copyright holder 1950 receives 1962 a copyright revenue 1960, which may be based, at least partly, upon 1932 the service revenue 1930. The amount of the copyright revenue 1960 may, preferably, be based upon an agreement 1952 between the copyright holder 1960 and the service provider 1900.

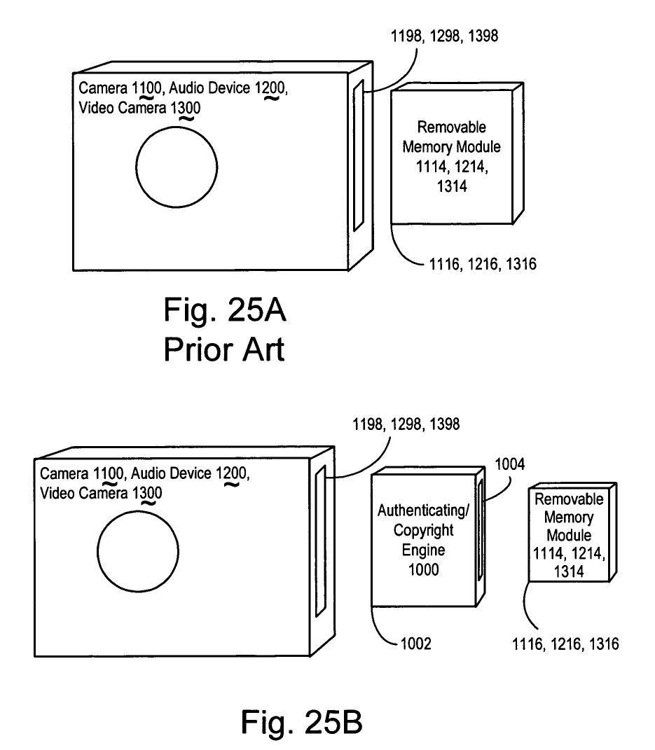

FIG. 25A shows an exploded diagram of a prior art media format instance generator 1100, 1200, and/or 1300, and a removable memory module 1114, 1214, and/or 1314. The prior art media format instance generator lacks the features of the invention's creations. The media format instance generator may include any combination of a digital camera 1100, a digital audio recording device 1200 and/or a digital video camera 1300. The removable memory module 1114 includes an interface 1116 fitting into slot 1198 of a digital camera 1100. The removable memory module 1214 includes an interface 1216 fitting into slot 1298 of a digital audio recording device 1200. The removable memory module 1314 includes an interface 1316 fitting into slot 1398 of a digital video camera 1300.

FIG. 25B shows an exploded diagram of the prior art media format instance generator of FIG. 25A communicating via an authenticating/copyright engine 1000 with the removable memory module.

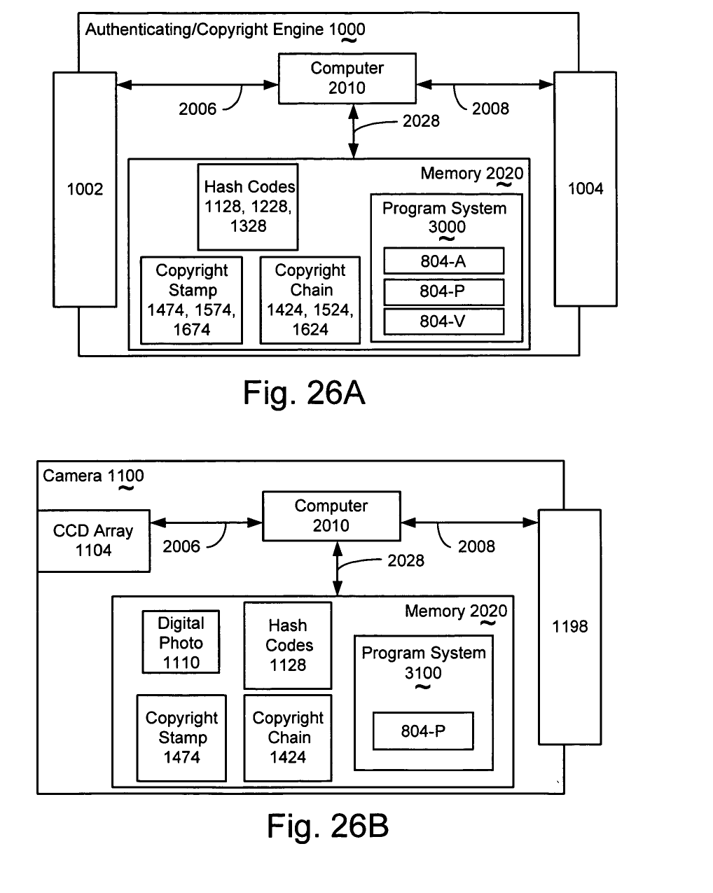

FIG. 26A shows a simplified block diagram of the authenticating/copyright engine 1000 of FIG. 25B.

The authenticating/copyright engine 1000 of FIGS. 25B and 26A, preferably operates at least as a media format engine 804, capable of marking a media format instance 2 with authentication and/or copyright watermarks.

The engine 1000 of FIGS. 25B and 26A, preferably includes a coupling interface 1002, which may couple in the slot 1198 with the digital camera 1100. The engine 1000 also includes a coupling interface 1004, which may further interface to a removable memory module 1114, for used with a digital camera 1100.

The coupling interface 1002 of FIGS. 25B and 26A, may preferably couple in the slot 1298 with the digital audio recording device 1200. The coupling interface 1004 may preferably couple with a removable memory module 1214, for use with a digital audio recording device 1200.

The coupling interface 1002 of FIGS. 25B and 26A, may preferably couple in the slot 1398 with the digital video camera 1300. The coupling interface 1004 may preferably couple with a removable memory module 1314, for use with a digital video camera 1300.

In normal operation, the coupling interface 1004 of FIGS. 25B and 26A preferably receives a mating interface 1116 with the removable memory device 1114 for the digital camera 1100. The coupling interface 1004 preferably receives the mating interface 1216 with the removable memory device 1214 for the digital audio recording device 1200. The coupling interface 1004 preferably receives the mating interface 1316 with the removable memory device 1314 for the digital video camera 1300.

In FIG. 26A, the authenticating/copyright engine 1000 includes a computer 2010 communicatively coupling 2006 with coupling interface 1002. The computer 2010 is communicatively coupled 2008 with the coupling interface 1004. The computer 2010 is accessibly coupled with the memory 2020. The memory 2020 includes a program system 3000, which operates using at least one version of the media format engine 804. The versions of the media format engine include a version 804-A for one-dimensional data streams 102, a version 804-P for instances of two-dimensional content 104, and a version 804-V of two-dimensional streams 106 of FIG. 4F.

When the program system 3000 of FIG. 26A operates as 804-A for one-dimensional data streams 102 of FIG. 4F, the memory 2020 may include a version 1228 of the hash codes associated with the digital audio file formats. When the program system 3000 operates as 804-P for instances of two-dimensional content 104, the memory 2020 may include a version 1228 of the hash codes for digital photos. When the program system 3000 operates as 804-V of two-dimensional streams 106 of FIG. 4F, the memory 2020 may include a version 1228 of the hash codes for digital video sequences.

When the program system 3000 of FIG. 26A operates as 804-A for one-dimensional data streams 102 of FIG. 4F, the memory 2020 may include a version 1574 of the copyright stamp(s) associated with the digital audio file formats. When the program system 3000 operates as 804-P for instances of two-dimensional content 104, the memory 2020 may include a version 1474 of the copyright stamp(s) for digital photos. When the program system 3000 operates as 804-V of two-dimensional streams 106 of FIG. 4F, the memory 2020 may include a version 1574 of the copyright stamp(s) for digital video sequences.

When the program system 3000 of FIG. 26A operates as 804-A for one-dimensional data streams 102 of FIG. 4F, the memory 2020 may include a version 1524 of the copyright chain associated with the digital audio file formats. When the program system 3000 operates as 804-P for instances of two-dimensional content 104, the memory 2020 may include a version 1424 of the copyright chain for digital photos. When the program system 3000 operates as 804-V of two-dimensional streams 106 of FIG. 4F, the memory 2020 may include a version 1524 of the copyright chain for digital video sequences.

FIG. 26B shows a digital camera 1100 in accord with the invention. The digital camera 1100 includes a computer 2010 communicatively coupling 2006 with a CCD array 1104. The computer 2010 is communicatively coupled 2008 with the coupling interface 1198. The computer 2010 is accessibly coupled 2028 with the memory 2020. The memory 2020 includes a program system 3100, which operates using at least one version of the media format engine 804, preferably a version 804-P for instances of two-dimensional content 104 of FIG. 4F.

The memory 2020 of FIG. 26B may include the following. A version 1228 of the hash codes for digital photos. A version 1474 of the copyright stamp(s) for digital photos. And a version 1424 of the copyright chain for digital photos.

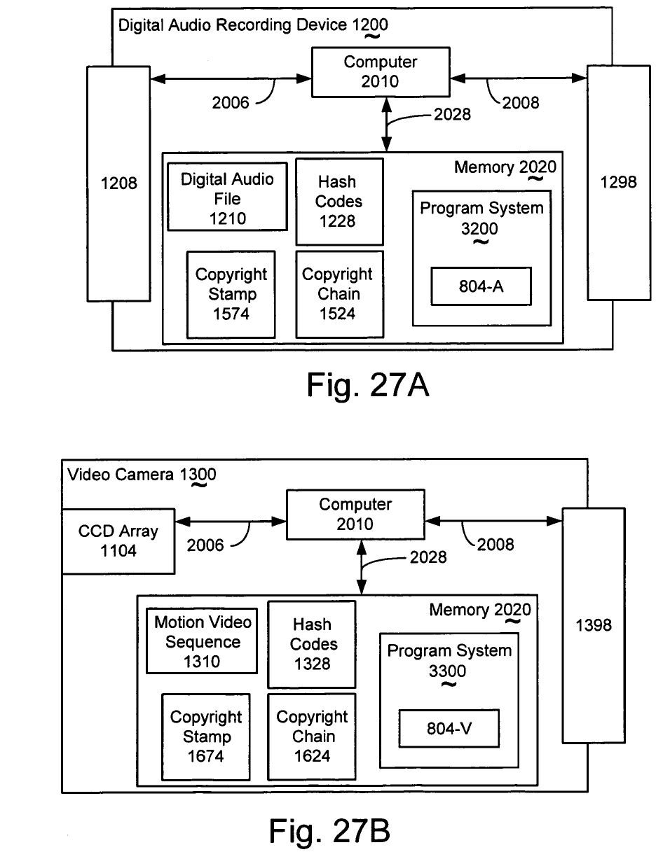

FIG. 27A shows a digital audio recording device in accord with the invention. The digital audio recording device 1200 includes a computer 2010 communicatively coupling 2006 with an audio micro-phone interface 1208. The computer 2010 is communicatively coupled 2008 with the coupling interface 1298. The computer 2010 is accessibly coupled 2028 with the memory 2020. The memory 2020 includes a program system 3200, which operates using at least one version of the media format engine 804, preferably a version 804-A for data streams of one-dimensional content 102 of FIG. 4F.

The memory 2020 of FIG. 27A may include the following. A version 1228 of the hash codes for digital audio data files. A version 1574 of the copyright stamp(s) for digital audio data files. And a version 1524 of the copyright chain for digital audio data files.

FIG. 27B shows a digital video camera in accord with the invention. The digital video camera 1300 includes a computer 2010 communicatively coupling 2006 with a CCD array 1104. The computer 2010 is communicatively coupled 2008 with the coupling interface 1398. The computer 2010 is accessibly coupled 2028 with the memory 2020. The memory 2020 includes a program system 3200, which operates using at least one version of the media format engine 804, preferably a version 804-V for data streams of two-dimensional content 106 of FIG. 4F.

The memory 2020 of FIG. 27B may include the following. A version 1328 of the hash codes for digital audio data files. A version 1674 of the copyright stamp(s) for digital audio data files. And a version 1624 of the copyright chain for digital audio data files.

FIG. 30A shows the field mark specifier 190 of FIG. 7A further including a second field length 192-2. FIG. 30B shows the field mark specifier 190 of FIG. 30A further including a field coupling specifier 194. FIG. 30C shows the field mark specifier 190 of FIG. 30B further including a combiner field length 196.

FIG. 30D shows the mark profile list 186 of FIG. 7A including a second mark profile 188-A. The second mark profile 188-A includes a field mark specifier 190-A. The field mark specifier 190-A includes a field length 192-A and a field encoding specifier 198-A.

FIG. 30E shows the second mark profile 188-A of FIG. 30D further including a mark coupler specifier 193.

FIG. 30F shows the mark profile list 186 of FIG. 7A including a mark coupler profile 191, which includes the following. A first input profile indicator 195-1. A second input profile indicator 195-2. The output profile indicator 197. And a profile coupler specifier 199.

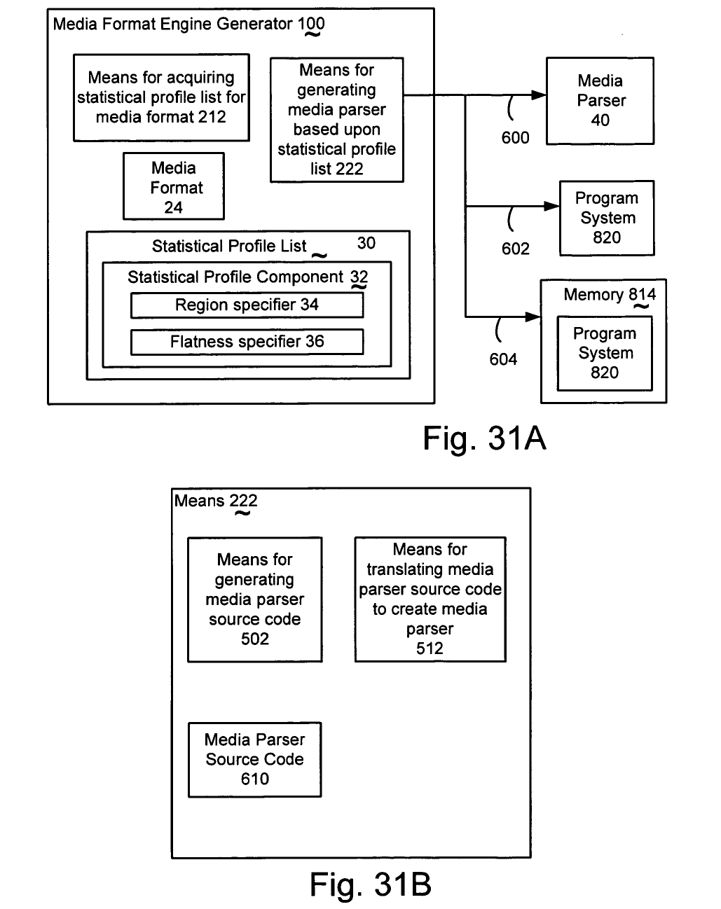

FIG. 31A shows an alternative embodiment of the method of FIGS. 1A and 2B showing the steps of the method implemented as means for performing those steps.

FIG. 31B shows a detail of the means for implementing generating 222 the media parser 40 of the preceding Figures.

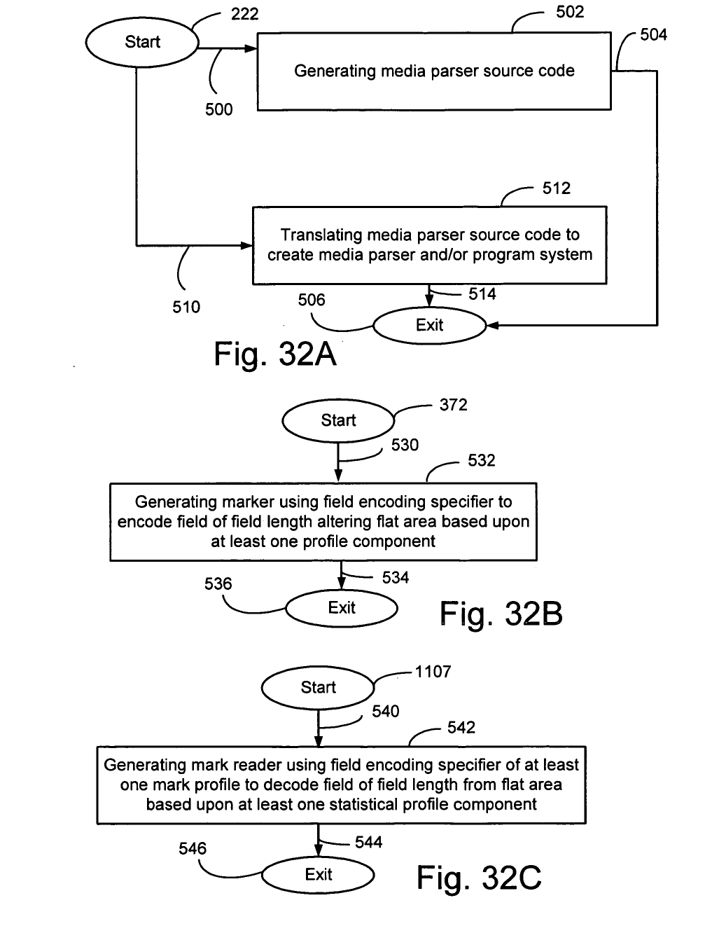

FIG. 32A shows the flowchart of the generating 222 the media parser 40 of FIGS. 1B, 31A, and 31B.

Means 212 of FIGS. 1B and 21A for acquiring the statistical profile 30 for the media format 24 may include may include acquiring from a disk operating system and/or a file management system. Acquiring may occur across a network, which may further include acquiring across a Wide Area Network (WAN), LAN, and/or the Internet.

In FIGS. 31A and 31B, the generating 222 of the media parser 40 includes generating the media parser, in its entirety 40, and/or the program system 820 of FIG. 9A, and/or with the program system 820 residing in at least part of second memory 814. Any of these generated products are articles of manufacture, templates and/or prototypes for such manufactured articles, and are useful and novel in themselves.

In FIGS. 31B and 32A, examples of the generating 222 of the media parser 40 are shown which may includes the following. Generating 502 the media parser source code 610. And translating 512 the media parser source code 610 to create the media parser 40 and/or its program system 820.

FIG. 32B shows a detail flowchart of operation 372 of FIG. 7B further generating the marker 180 of the preceding Figures, for at least one of the mark profiles. Operation 532 generates the marker using the field encoding specifier 198 of the at least one mark profiles 188 of FIG. 7A, to encode a field of the field length 192 altering a flat area 72 in the flat area list 70 of the FIGS. 3B, 9B, 10A, and 13, based upon at least one of the profile components 32 of FIG. 1A.

FIG. 32C shows a detail flowchart of operation 382 of FIG. 7B further generating the mark reader 182 of FIG. 7A, for at least one of the mark profiles 188. Operation 542 generates the mark reader using the field encoding specifier 198 of the at least one mark profiles 188 to decode a field of the field length 192 from a flat area 72 based upon at least one of the statistical profile components 32.

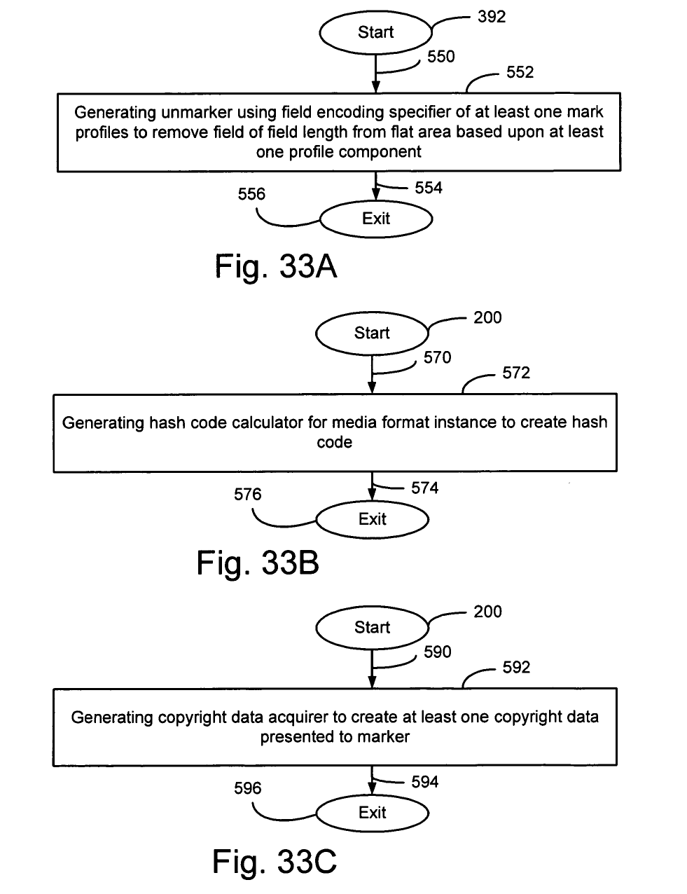

FIG. 33A shows a detail flowchart of operation 392 of FIG. 7B further generating the unmarker 184 of FIG. 7A, for at least one of the mark profiles 188. Operation 552 generates the unmarker using the field encoding specifier 198 of the at least one mark profiles 188 to decode a field of the field length 192 from a flat area 72 based upon at least one of the statistical profile components 32.

FIG. 33B shows the invention's method 200 of FIGS. 1A, 1B, and 7A further generating engines for media formats. Operation 572 supports generating a hash code calculator as in FIGS. 15A to 17B, 21A, 21C, 22A, 22C, 23A, 23C, 24, and 26A to 27B for instance such as 1010, 1070, 1210, 1270, 1310, and 1370, of the media format 24 of the previous Figures to create the hash code such as 1128, 1228, and 1328 based upon the corresponding the media format instance.

FIG. 33C shows the invention's method 200 of FIGS. 1A, 1B, 7A and 33B, further generating engines for media formats.

In FIG. 33C, operation 592 supports generating a copyright data acquirer, such as 1420, 1520, 1620 of FIGS. 18A, 19A, 20A, 21B, 21C, 22B, 22C, and 23B to 24, to create at least one copyright data, such as 1474, 1574, 1674, 1424, 1524, 1624 of FIGS. 26A to 27B, presented to the marker 180, as disclosed herein.

One can see that the generation of the hash code calculator may be further generate one or both of the following. Presenting the hash code to the copyright data acquirer, as in FIGS. 21C, 22C, 23C and 24. Presenting the hash code to the marker in the media format engine 804, as in FIGS. 15A, 16A, 17A, 21A, 22A, and 23A.

The present invention provides a system and method for making systems and methods marking, reading, and unmarking a media format instance 2 that contains a flat area 72. The flat area 72 will refer to a set of data values in the media format instance 2 and/or the transformed media 48 in which the data values vary within a certain amount of each other. The flat area 72 can be located within any pattern of values. The length of the set can be any number of data values greater than one.

Examples of embodiments of the invention will be discussed in the following order. First in terms of a two-dimensional media format instance 2 as a digital photo 1010, as in FIG. 15A. Then in terms of one-dimensional media format instance 2 as a digital audio file 1210, as in FIG. 16A. And lastly, in terms of three-dimensional media format instance 2 as a motion video sequence 1310, as in FIG. 17A.

One central element is the concept of a flat area 72. Flat areas are almost always found in recordings or transmissions of natural information, e.g., a still picture, a motion picture, an audio recording, an audio transmission, a measurement of radio signals or other forms that occur in nature, etc. Examples of flat areas in real life may be found in data representing a sky, a tree, a speaker's voice, a bass guitar solo, etc.

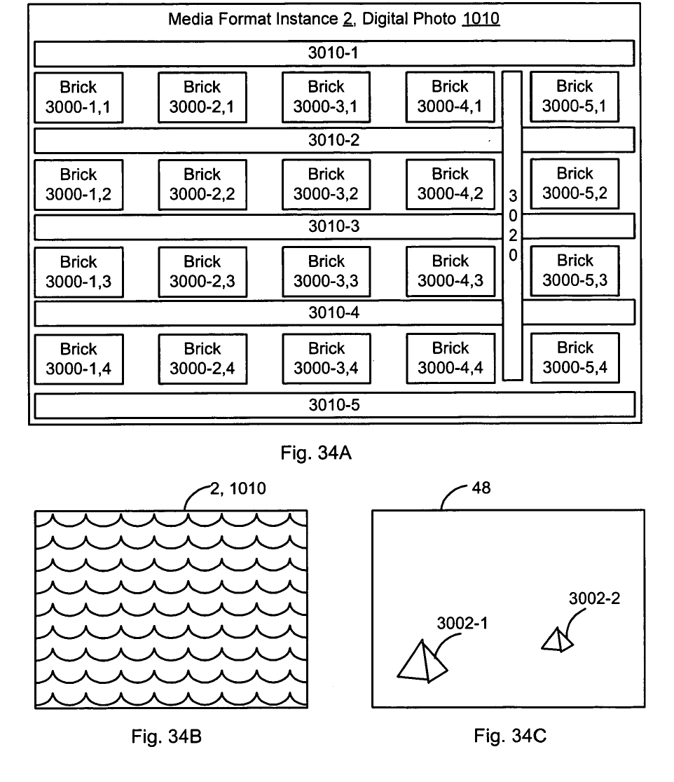

Consider the example found in FIG. 34A of the media format instance 2, of the digital photo 1010 of FIG. 15A, containing bricks and mortar. The bricks form an essentially rectangular array from 3000-1,1 to 3000-5,4. The mortar is shown in horizontal areas from 3010-1 to 3010-5, with one vertical area shown as 3020. Each of these bricks and lines of mortar tend to be perceived as a flat area 72, with their local variations either unnoticed or overlooked by most people. Each line of mortar may have variations in texture, thickness, and/or width. The face of a brick often has variations in texture and color, possibly including other matter, dirt or aggregate. This invention uses these overlooked variations to encode information, for example, at least one hash code 1030, which can confirm the provenance of the digital photo, its copyright holder(s), as well as other application related information. The hash code is embedded in the digital photo to create the digital photo with watermark 1040.

Consider another example found in FIG. 34B, of the media format instance 2, and the digital photo 1010 of FIG. 15A, with no regions with small local variations in color. This may occur in a picture of choppy waves or a close up of bark on a tree. However, a 2-D transform of the digital photo will often reveal a relatively small number of active components in the transformed media 48, as shown in FIG. 34C, leaving most of the rest of the transform media with small local variations, and opportunities for at least one flat area.

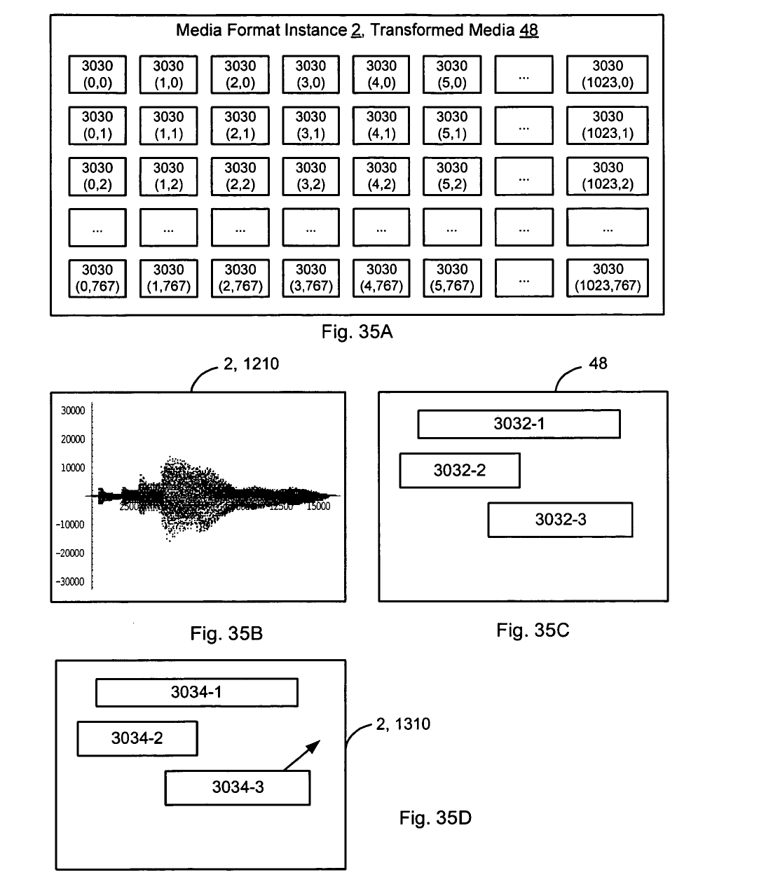

FIG. 35A may be used to shows an example 1024 by 768 pixel array representation of the media format instance 2, in particular, of the digital photo 1010 of FIG. 15A, 34A, and 34B. The digital photo includes first row having pixel 0, 3030 (0,0), pixel 1, 3030 (1,0), pixel #2, 3030 (2,0), etc.; and a second row having pixel #1024, 3030 (0,1), pixel #1025, 3030 (1,1), pixel #1026, 3030 (2,1), etc. Each pixel may be represented by a data value, often called a pixel. A pixel may have a value represented by a single number, such as often found in table driven color systems, or a combination of multiple numbers, often known as color components. The color components may be based upon a number of schemes discussed earlier. One example is a Red-Green-Blue (RGB) color scheme. While the digital photo 1010 may originally be in an alternative format, such as JPEG 142, the acquiring of the digital photo may preferably include conversion from the format into an array representation similar to FIG. 35A. One preferred embodiment such representations may favor the use of a two component pixel, similar to the 4-2-2 sampling scheme found in JPEG. One component is always the luminance, and the two chrominance components are used in alternating pixels.

FIG. 35A may also be used to show an example of the transformed media 48 of FIG. 34C. Typically such a representation may have as many rows and columns of data values 3030 (I,J) where I ranges across columns of the digital photo 1010 and J ranges across the rows. Note that in some preferred embodiments, using the array of the digital photo with the two component pixels of alternating chrominance components directly supports the calculation of a two dimensional FFT to generate the transformed media.

Consider the media format engine generator 100 of FIG. 1A creating 12 the media parser 40 for use with the media format instance 2 of FIGS. 3B and 9B, of a digital photo 1010, as in FIGS. 15A and 15B. The statistical profile list 30 and the media format 24 are used to create the media parser 40. In particular, the media format 24 may be used to create the acquisition mechanism designated by the arrow 816 in FIG. 9B. The acquisition mechanism 816 may translate the JPEG 142 format to an array of luminance-chrominance pixels to create the media format instance 2 as in FIGS. 3B, 9B, 34A, 34B, and 35A. The media format 24 may also be used to create the transform processor 46, which, acting upon the media format instance 2 of FIG. 35A, creates the transformed media 48 of FIG. 3B, 9B, 34C, and 35A.

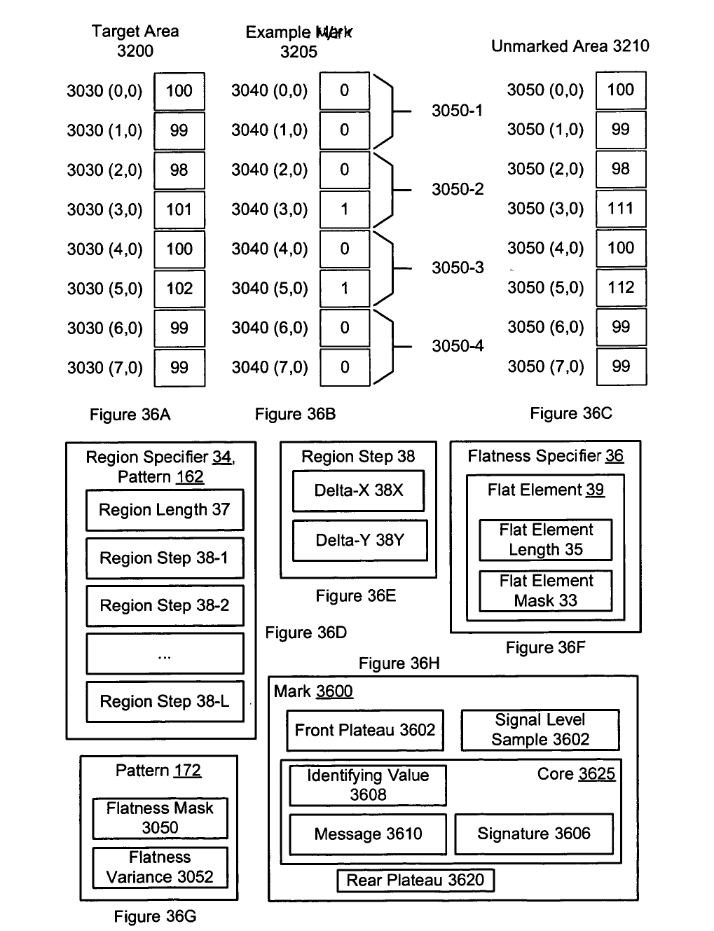

To continue the example of creating the media parser 40 for a digital photo 1010 as shown in FIGS. 15A and 15B, the statistical profile component 32 may be used to create a region recognizer 42 and flat area discriminator 44 of FIGS. 1A, 3B and 9B. The region specifier 34 directs the creation 12 of the region recognizer 42. The flatness specifier 36 directs the creation 12 of the flat area discriminator 44. As a first example of a region recognizer 42, consider a region specifier 34 that specifies looking for non-overlapping horizontal strips 8 pixels long, starting from a base address. Then an unmarked area 3210 of FIG. 36C would be selected by the region recognizer 42 as a recognized region 62 to be added 43 to the recognized region list 60. Suppose the flatness specifier 36 includes a direction to use.

An example system and method place a content-identifying mark within the flat area of the data file. If alteration is performed on the original data, either the mark will not match the data or the mark itself may be damaged. The system and method attempt to modify the original data as little as possible, enable removal of the mark from the data, and, if unmodified, enable return of the original data. This would help ensure the integrity of the digital data involved and has many applications including ensuring the validity of digital photographs, digital motion pictures and digital voice or sound recordings for use as evidence in a court of law. Another use ensures the validity of scientific research data recorded by instruments or the validity of data transmitted over computer networks, radio transmission or other means. Other example systems and methods can place a copyright notice, an author's name, an identification number, an authenticator's number, the camera manufacturer's number, digital data licensee's information. etc. in the captured frame.

By way of example, the flat area discriminator 44 may preferably select a portion of the media format instance 2 for marking. For digital still image data such as the digital photo 1010 of FIG. 15A, the flat area discriminator may preferably select the bitmap for each color (e.g., each of RGB, each of CMYK, each of gray-scale, or each of another color combination) of an entire frame.

By way of example, the flat area discriminator 44 may preferably select a portion of the media format instance 2 for marking. By way of example, in the motion video sequence 1310 of FIG. 17A, the flat area discriminator may preferably select each bitmap of each color of each frame to select a flat area 72. Although bitmaps representing color are being selected herein, it will be appreciated that the flat area discriminator alternatively or additionally may select the map for intensity or other values.

By way of example, the flat area discriminator 44 may preferably select a portion of the media format instance 2 for marking. In audio recording, shown as a digital audio file 1210 as in FIG. 16A, examples of a flat area 72 in the digital audio file 1210 may include a set of sound samples of a particular volume. The flat area discriminator 44 may preferably select each track of the entire digital audio file. If a digital audio file is too long, the digital audio file may be broken into smaller frames. For a continuous audio or video transmission, the transmission must be broken into predetermined blocks or frames.

It will be further appreciated that the media parser 40 may select multiple image frames, multiple audio frames, etc. or combinations thereof.

The flat area discriminator 44 preferably searches each and/or enough of selected portions for a “flat” target area where a content-identifying mark can be placed. The flat area discriminator 44 preferably searches the selected portion in a predetermined order, e.g., starting from the upper left pixel and moving rightward across the row and downward through the rows.

For a digital still image, shown in FIG. 15A as a digital photo 1010, the flat area discriminator 44 searches for a segment of pixels. Each pixel in the segment may preferably be represented by a data value, e.g., color value, which varies no more than a particular amount relative to the other pixels in the segment. For example, for a gray-scale image, the flat area discriminator 44 searches the gray-scale bitmap for a segment where each pixel has a gray value within a particular range of the other pixels in the segment. In a real life image, this segment maybe found, for example, in a skyline, in a tree, in the body of an automobile, or in another relatively constant color surface.

For an audio recording, shown in FIG. 16A as a digital audio file 1210, the flat area discriminator 44 searches the frame track for a segment of sound samples. Each sound sample in the segment may preferably be represented by a data value, e.g., volume, that varies no more than a particular amount relative to the other sound samples in the segment. In a real life audio recording, the segment may be found, for example, in a bass guitar, in a voice, in a quiet pause, or in another relatively uniform sound. It will be appreciated that the length of the segment need only be as long as the mark, e.g., fifty-two (52) pixels.

The flat area discriminator 44 attempts to find a flat area 72 with the least amount of variance. The flat area discriminator searches the selected portion for a segment having data values where no bits change between the words. If the flat area discriminator does not locate an area satisfying this criterion, it searches the selected portion for a target area having data values where, at most, the least significant bit changes between data values, but no other bits change. Again, if the flat area discriminator does not locate an area satisfying this criterion, it searches the selected portion for a target area having data values where, at most, the least two significant bits change, but no other bits change. The flat area discriminator repeats this process until an area is found where, at most, all bits but the most significant bit in the data values of the segment change. The “flatness value” represents the depth necessary to locate unchanging bits. Accordingly, the flatness value can be computed as the number of changing bits plus one (1). It will be appreciated that the flat area discriminator may search for a flat area, which has a set flatness value, for example, of six (6) bits.

If the flat area discriminator 44 does not find an area that satisfies one of these tests, then the flat area discriminator may search for a flat area 72 in the transformed media 48. The flat area discriminator 44 preferably attempts to find a target area having the least variance so that the mark 3600 goes as unnoticed as possible. Accordingly, the mark will be quite subtle if displayed in its marked state.

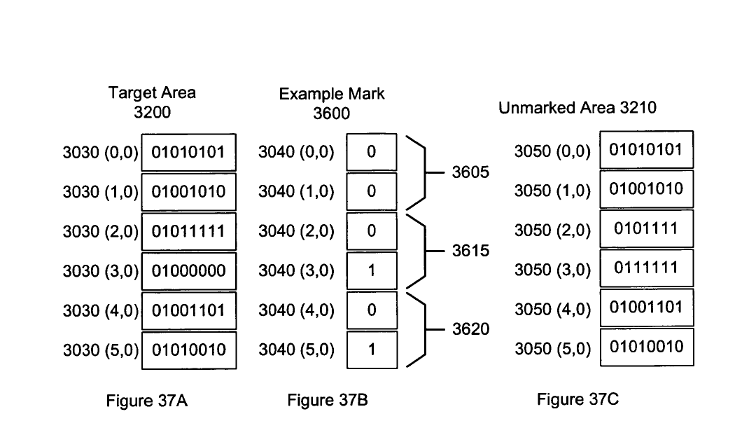

If the flat area discriminator 44 does not find an area that satisfies one of these tests, then using the techniques of this invention to mark the file is not possible. However, real life data will almost always have a flat target area. The mathematics of locating a flat target area are described in greater detail below with reference to FIG. 37B through FIG. 37D. It will be appreciated that the flat area discriminator 44 attempts to find a target area having the least variance so that the mark goes as unnoticed as possible. Accordingly, the mark will be quite subtle if displayed in its marked state.

The mark reader 182 computes a content-identifying value for the unaltered original data of the selected portion. For example, the mark reader 182 may determine a checksum, limited to a predetermined number of bits such as twenty-four (24), for the selected portion. Alternatively, the mark reader 182 may perform predetermined hashing functions on random or all the data in the selected portion to compute the content-identifying value. The content-identifying value will be used to verify the authenticity of test data. Thus, the mark reader 182 should use an algorithm that is based on the content and that provides a sufficient amount of uniqueness to recognize altered data.

The encoder 842 enables the encryption of the content-identifying value for added security. The manufacturer may determine whether to use encryption and, if so, which encryption algorithm to use. Again, like other elements described herein, the encoder 842 is optional.

The marker 180 encodes the mark into the flat target area located by the flat area discriminator 44. As shown in FIG. 36H, a mark 3600 may include a front plateau 3605, the optional signature 3610, the content-identifying value 3615, and a rear plateau 3620. The portion of the mark containing actual content is referred to herein as the core 3625. In this case, the core 3625 may include the data between the front plateau 3605 and the rear plateau 3620. It will be appreciated that the regions in the core 3625 can have any order, so long as the mark reader 182 knows the order. In this example, the front plateau 3605 and rear plateau 3620 are used as a beacon to enable finding the marked area for subsequent decoding. Based on the sizes of each of front plateau 3605, signature 3610, content-identifying value 3615 and rear plateau 3620 set by the mark profile list 186, in particular the field length 192 of each field mark specifier 190, the size of the mark 3600 can be determined. For example, the front plateau 3605 may be ten (10) bits, the signature 3610 may be sixteen (16) bits, the content-identifying value 3615 may be sixteen (16) bits, and the rear plateau may be ten (10) bits, thereby creating a mark 3600 fifty-two (52) bits long.

An example of encoding a mark 3600 into a target area is illustrated and described with reference to FIG. 37B through FIG. 37D. Generally, to represent a one (1) bit in the core 3625, the marker 180 inverts the varying least-significant bits and the next constant bit of the attribute value corresponding to the core bit. To represent a zero (0), no bits are changed. Since the bits representing a one (1) no longer satisfy the flatness criteria, the core bits can be determined easily and the data can be returned to their original state easily. One skilled in the art will also recognize that you can invert the meaning of encoding for a 0 bit and a 1 bit as well. Inverting the encoding method or meaning of 0 and 1 is optional.

The mark reader 182 searches the selected portion in the same order as the marker 180. Knowing the length of each plateau 605 and 620 and the length of the core 3625, the mark reader 182 searches for flat areas in segments where a front plateau 605 and a rear plateau 3620 could be and ignores the segment where a core 3625 would be.

By way of example, assume each front plateau 3605 and rear plateau 3620 are ten (10) bits long, and each core 3625 is thirty-two (32) bits long. The mark reader 182 searches the selected portion for two sets often (10) data values that satisfy the flatness criteria and that are separated by thirty-two (32) data values. If so, then the mark reader 182 selects the area as a candidate, or possible, mark area. If not, then the mark reader 182 cannot verify the authenticity of the selected portion. It will be appreciated that a mark 3600 may include only a single plateau, e.g., a front plateau 605, a rear plateau 3620 or a middle plateau. Knowing the length of the core 3625, the mark reader 182 need only locate the plateau. It will be further appreciated that a mark 3600 need not include a plateau at all. The mark reader 182 can search a given location for a mark. However, because flatness is being assumed at this given location, this embodiment will likely fail an undesirable percentage of times.

As with the marker 180, the mark reader 182 searches the selected portion for a flat area 72 having no changing bits between data values, then for a flat area having only one changing bit between data values, etc., until either a flat area is found or until it is determined that the most significant bit of each attribute value is also not constant. As stated above, since the flatness value represents the depth necessary to locate the unchanging bits, the flatness value can be computed as the number of changing bits plus one (I). It will be appreciated that, if the flatness value is a preset number, then the mark reader 182 will search for a flat area of the preset flatness value.

As an example, if the media parser 40 locates a candidate mark area, then the unmarker 184 attempts to extract the core 3625 and to replace it with the assumably original unmarked data. First, the unmarker 184 tries to reconstruct the core 3625 one bit at a time. The unmarker 184 uses the same flatness value that the mark reader 182 needed to find the front plateau 3605 and the rear plateau 3620. The unmarker 184 retrieves any one of the data values in the front plateau 3605 and/or the rear plateau 3620, and retrieves the first attribute value that maps to the first bit of the core 3625. The unmarker 184 compares the absolute difference between the plateau attribute value and the core-corresponding attribute value, and compares the absolute difference between the plateau-corresponding attribute value and the core-corresponding attribute value having the n least-significant bits inverted. If the difference computed with the inverted bits is greater than the difference with the un-inverted bits, then the unmarker 184 assumes the core bit is a zero. If the difference computed with the inverted bits is smaller than the difference with the un-inverted bits, then the unmarker 184 assumes the core bit is a one.

FIG. 35B illustrates an example digital audio wave, having sampled data at time zero, one, two, etc. Each digital sample is represented by a data value (e.g., one byte).

FIG. 37A illustrates an example of a target area 3200. The target area may include six (6) of the data value 3710, wherein each attribute value 3030 represents a color value for each pixel of pixels (0,0) through (5,0). The example color values for these pixels are represented in binary notation as 01010101, 01001010, 001011111, 01000000, 01001101 and 01010010.

The marker 180 examines each data value 3710 to determine that the sixth, seventh and eighth bits for each value are constant. That is, the marker 180 determines that the target area 3200 has a flatness value of six (6) or is flat at a depth of six (6) bits. For this example, it is assumed that there are no areas in the file which have a variance of less than six (6) bits. Accordingly, the marker 180 sets the flatness value (n) to six (6) and a value (m) identifying the remaining bits to two (2).

FIG. 37B illustrates an example of a mark 3600. The mark 3600 includes six (6) bits, namely, 000100, wherein each bit will be embedded into one data value 3710. The mark 3600 includes a two (2) bit front plateau 3605 (00), a two (2) bit content-identifying value 3615 (01), and a two (2) bit rear plateau 3620 (00). In this instance, the core 3625 is two (2) bits. The front plateau 605 and rear plateau 3620 are preferably all zeros, so that no changes are made to the data values 710 corresponding to the plateau regions 605, 620 and so that the plateau regions 605, 620 can be found again easily.

FIG. 37C illustrates the example mark 3600 embedded into the example target area 3200. The resulting target area still includes six (6) marked data values 3030. For each one bit in mark 3600, the marker 180 inverted the n least-significant bits. That is, since only the second bit of the identifying value 615′ is high, the marker 180 inverted the six (6) least significant bits of only the fourth attribute value 710, from 01000000 to 01111111. The other data values 710 remain the same.

First, the above embodiments have been described with reference to finding a flat area 72 to embed a message within a series of binary numbers. In a different embodiment, the marker 180 locates a flat area within a series of decimal numbers to embed a mark 3600. For example, the series of numbers “120, 121, 123, 131, 134, 131, 131, 118 . . . ” may be deemed a flat area. A low value or a 0 bit may be represented as the number unchanged. A high value or a 1 bit may be represented as the number modified by some recognizable amount, e.g., by adding 40. To determine the state of a value, the marker 180 and unmarker 184 can set a reference half the recognizable amount from the average low value. For the above series, the average value is about 126. Therefore, the reference can be set about 20 (i.e., about ½ of 40) away from 126, for example, to 146. The marker 180 and unmarker 184 can define any values below 146 as low values and any values above 146 as high values. One skilled in the art will recognize that the states can be reversed. Further, the unmarker 184 can subtract the recognizable amount from the high values to obtain the original values. It will be appreciated that, if the original values change due to lossy compression, the reference will follow the values.

Second, the above embodiments have been described with reference to finding a flat area within a consecutive series of numbers to embed a mark 3600. In a different embodiment, the marker 180 can locate a flat area of any predetermined pattern to embed the mark 3600. The pattern may be based on a function (such as every other number) or on an irregular pattern (such as the first number, the eighth number, the twelfth number, etc.).

The pattern 172 may be one-dimensional as shown and discussed for a digital audio file 1210 in FIGS. 16A, 16B, 19A, 19B, and 22A to 22C, two-dimensional as shown and discussed for a digital photo 1010 in FIGS. 15A, 15B, 18A, 18B, and 21A to 21C, or three-dimensional as shown and discussed for a motion video sequence 1310 in FIGS. 17A, 17B, 20A, and 20B. So long as the pattern is known, the flat area 72 can be located repeatedly. In another similar embodiment, the marker 180 may have multiple predetermined fixed patterns and may go through the patterns to find the most promising flat area. It will be appreciated that, when using a predetermined pattern to locate the flat area, the front plateau 3605 and/or the rear plateau 3620 may be unnecessary. However, the front plateau and/or the rear plateau may be preferred to determine the best reference for gauging low and high values.

Third, since lossy compression may cause the original values containing a mark 3600 to change, the difference between low and high values may no longer be the recognizable amount. For example, an original low embedded value of 120 after lossy compression may be at 110, and an original embedded high value of 160 after lossy compression may be at 140. The original recognizable amount was 40 and is now 30. Accordingly, the marker 180 can place one or more known high values, i.e., peaks, in the core 3625 to provide for dynamic gauging. The unmarker 184 can use the difference between the average of the known low values (e.g., now 110) and the average of the known peaks (e.g., now 140) to determine the new recognizable amount (e.g., now 30) and thus the new reference (e.g., now 110+15=125). The unmarker 184 can subtract the new recognizable amount (e.g., 30) from the high values to obtain the approximate original values after lossy compression.

Fourth, consider the following example embedding a mark 3600 in a motion video sequence 1310 or a digital photo 1010. The marker 180 may acquire the media format instance 2 to create the transformed media 48 in the format of the frame to a YCrCb format, since Y (or luminosity) tends to stay relatively constant after compression and decompression. The marker 180 can then locate a flat area 72 in the luminosity values in which to embed the mark 3600. The marker 180 can then embed the mark 3600 within the flat area, and the format conversion engine can reformat the frame back to its original format. To extract the mark 3600, the mark reader 182 can first convert the media format instance 2 to YCrCb format. The mark reader 182 can then search the luminosity values for the mark area. Once found, the unmarker 180 can extract the mark 3600 from the flat area, can return the luminosity values back to their almost original values. The format conversion engine can then reformat the frame to its original format. Format conversion alone is well known.

Fifth, in another embodiment, the marker 180 represents a single high or low embedded value by multiple data values, e.g., multiple pixels. For example, three low pixel values can represent a low embedded value, and three high pixel values can represent a high embedded value. Thus, if one of the pixel values were to change dramatically after lossy compression, the other two pixel values could balance the change.

Sixth, the above embodiments have been described with reference to searching for a flat area in a frame in its original orientation. However, the mark reader 182 can rotate the frame circularly (e.g., in 90 degree increments), flip the frame over along a horizontal axis or flip the frame over along a vertical axis, and then search for a target area. It will be appreciated that only the location of the data values may have changed. The image content may have remained the same. The mark reader 182 can search each of the orientations to locate an embedded mark 3600.

Seventh, although the above embodiments have been described with reference to embedding only one copy of a mark 3600, the marker 180 and marker 180 can embed redundant copies of a mark 3600 at multiple locations. It will be appreciated that, if data is cropped, redundant copies provide a better chance of extracting at least one of the marks 600.

Eighth, for an embodiment using a non-consecutive functional pattern of pixels, e.g., every third pixel, in which to embed a value, the mark reader 182 may ramp up or ramp down the separation between pixels when searching for a mark 3600 to account for possible scaling. For example, if an image that contains a mark 3600 embedded using a pattern of every third pixel is enlarged, then additional pixels may be added to enlarge the image. Accordingly, if one pixel is added every three pixels, then the mark 3600 will be found embedded using a pattern of every fourth pixel. If an image is reduced in size, then pixels may be removed to shrink the image. The mark reader 182 manipulates the known pattern (i.e., ramp up or ramp down) to attempt mark location. Accordingly, if every third pixel (offset by one) is removed, then the mark reader 182 would search for the mark 3600 embedded in every second pixel.

Ninth, to make an embedded mark 3600 less visible when displayed, the marker 180 may use a two-dimensional or three-dimensional pattern.

FIG. 36H may be used as a block diagram illustrating an example mark 3600 to be embedded into a flat area of decimal numerals. The example mark includes a front plateau 3605, a signal level sample 3640, a signature 3610, a message 3650 and a rear plateau 3620. As stated above, the front plateau and rear plateau are used to locate the mark. The core 3625 (embedded message) includes the signature and message. The signal level sample includes an embedded low and high value for reference purposes.

FIG. 36A is a block diagram illustrating an example target area 3200, which includes an area eight values wide (for pixels 0,0 to 7,0). The values illustrated include values 100,99,98,101,100,102, 99 and 99. The target area has a variance of at most four units.

FIG. 36B is a block diagram illustrating an example mark 3600, which includes eight values. The front plateau 3605 includes the values 0 and 0. To incorporate a known low and high value into the target area 3200, the signal level sample 3640 includes the values 0 and 1. The core 3625 includes the values 0 and 1. The rear plateau 3620 includes the values 0 and 0.

FIG. 36C is a block diagram illustrating the target area 3200 containing the embedded mark 3600, illustrated as values. Since the front plateau 3605 and rear plateau 3620 contain only low values, their values remain unchanged. However, the values being modified to represent a high value have been raised in this embodiment by the recognizable amount of ten. Accordingly, since it is known that the first three values and last two values are lows and the fourth value is a high, we can approximate the recognizable amount. That is, we compute the average of the known low values, 100, 99, 98, 99 and 99 as 99. We know that the data value of 111 represents a high value. Thus, we compute the recognizable amount at 111 minus 99, or 12. Thus, we know any value above 99 plus half of 12, or 105, is a high, and everything less than 105 is a low.

The preceding embodiments have been presented by way of example and are not meant to constrain the scope of the claims.

1. A method of generating an engine for a media format, comprising the step of:
acquiring a statistical profile list for said media format; wherein said statistical profile list includes at least one statistical profile component; wherein each of said statistical profile components includes a region specifier and a flatness specifier; and
generating said media parser based upon said statistical profile list, further comprising the steps of:
generating at least one region recognizer based upon at least one of said region specifiers included in at least one of said statistical profile components; and
generating a flat area discriminator based upon said region specifier and said flatness specifier.

2. The method of claim 1, wherein for each of said profile components, at least one of said region recognizers is at least partly based upon said profile component.

3. The method of claim 1, wherein said statistical profile list comprising at least two of said statistical profiles.

4. The method of claim 1, wherein at least one of said statistical profile components includes a transform specifier;
wherein the step of generating said region recognizer is further comprised of the steps of:
generating a transform processor of said media format based upon said transform specifier to create a transformed media; and
applying said region recognizer to said transformed media.

5. The method of claim 4,
wherein the step applying said region recognizer to said transformed media further comprises the step of:
applying said region recognizer to said transformed media creates a recognized region list including at least one recognized region;
wherein the step generating said flat area discriminator is further comprised of the step of:
generating said flat area discriminator to act upon said recognized region list to create a flat area list comprising at least one flat area based upon at least one of said recognized regions of said recognized region list.

6. The method of claim 4, wherein said transform specifier includes at least one transform specifier instance of at least one member of a transform specifier type list, comprising the members of a non-overlapping block transform list, an abutting block transform list, an isolated block transform list, a finite impulse response filter list, and an infinite impulse filter list.

7. The method of claim 6, wherein said non-overlapping block transform list comprises a Discrete Cosine Transform (DCT), a Fast Fourier Transform (FFT), a Walsh Hadamard Transform, a discrete orthogonal block transform; and a Discrete Wavelet Block Transform;
wherein said abutting block transform list comprises an Overlapping Fast Fourier Transform (OFFT), and a spline function;
wherein said isolated block transform list comprising a chirp transform and a soliton transform;
wherein said finite impulse response transform list comprising a Windowed Fast Fourier Transform, a filter bank, a high pass filter, a low pass filter, and a band pass filter; and
wherein each member of said infinite impulse response transform includes an input transform and an output accumulator transform.

8. The method of claim 4, wherein said media format includes at least one digital stream of a one-dimensional content.

9. The method of claim 8, wherein the step said generating said transform of said media format based upon said transform specifier is further comprised of the step of:
generating a transform of said one-dimensional content based upon said transform specifier to create said transformed media.

10. The method of claim 8, wherein said digital stream includes an amplitude sequence of said one-dimensional content.

11. The method of claim 8, wherein said digital stream includes a power spectrum of a window of said one-dimensional content.

12. The method of claim 4, wherein said media format includes at least one instance of a two-dimensional content.

13. The method of claim 12, wherein said media format includes at least one digital stream of a two-dimension content.

14. The method of claim 12, wherein said two-dimensional content includes a luminance component stream.

15. The method of claim 4, wherein said second statistical profile component further includes a sample structure comprising at least one sample component;
wherein said transformed media includes at least two samples of at least said sample component.

16. The method of claim 15, wherein said media format includes at least one digital stream of a one-dimensional content; and
wherein said sample component is a component of a power spectrum of a window of said digital stream.

17. The method of claim 16, wherein said digital stream is a version of an audio digital stream.

18. The method of claim 17, wherein said audio digital stream is compatible with a version of at least one member of the audio digital stream list comprising:
an MPEG audio layer;
an AC3 audio stream;
an SURROUND SOUND;
an Audio CDROM format; and
a DVD audio digital stream.

19. The method of claim 18, wherein said version of MPEG Level 1 audio includes at least one member of an MPEG Level 1 audio layer list including a layer one, a layer two, and a layer three.

20. The method of claim 15, wherein said media format includes at least one instance of a two-dimensional content; and
wherein said sample component is a luminance component of said instance.

21. The method of claim 20, said instance includes an expression compatible with at least one member of a JPEG format list including JPEG and JPEG 2000.

22. The method of claim 20, wherein said media format includes at least one data stream of said two-dimensional content; and
wherein said sample component is a luminance component of said digital stream.

23. The method of claim 22, where said data stream is compatible with a version of at least one member of a motion video standard list including: an MPEG Level 1, an MPEG Level 2, a DVD, an MPEG level 3, and an MPEG Level 4.

24. The method of claim 22, wherein said at least one region specifier includes a third of a predetermined pattern;
wherein the step generating said region recognizer is further comprised of the step of:
generating said region recognizer based upon said third predetermined pattern to act upon said luminance component of said digital stream.

25. The method of claim 22, wherein said at least one flatness specifier includes a sixth of a predetermined pattern;
wherein the step generating said flat area discriminator is further comprised of the step of:
generating said flat area discriminator based upon said sixth predetermined pattern to act upon said luminance component of said digital stream.

26. The method of claim 20, wherein said at least one region specifier includes a second of a predetermined pattern;
wherein the step generating said region recognizer is further comprised of the step of:
generating said region recognizer based upon said second predetermined pattern to act upon said luminance component.

27. The method of claim 20, wherein said at least one flatness specificier includes a fifth of a predetermined pattern;
wherein the step generating said flat area discriminator is further comprised of the step of:
generating said flat area discriminator based upon said fifth predetermined pattern to act upon said luminance component.

28. The method of claim 16, wherein said at least one region specifier includes a first of a predetermined pattern;
wherein the step generating said region recognizer is further comprised of the step of:
generating said region recognizer based upon said first predetermined pattern to act upon said component of said power spectrum.

29. The method of claim 16, wherein said at least one flatness specificier includes a fourth of a predetermined pattern;
wherein the step generating said flat area discriminator is further comprised of the step of:
generating said flat area discriminator based upon said fourth predetermined pattern to act upon said component of said power spectrum.

30. Said media parser as a product of the process of claim 1.

31. The method of claim 1, further comprising at least one member of the marking generator group consisting of the step of:
generating a marker based upon said statistical profile list and upon a mark profile list;
generating a mark reader based upon said statistical profile list and upon said mark profile list; and
generating an unmarker based upon said statistical profile list and upon said mark profile list;
wherein said mark profile list includes at least one mark profile;
wherein each of said mark profiles comprises at least one field mark specifier;
wherein each of said field mark specifiers comprises at least one field length and a field encoding specifier.

32. Said engine for said media format, as a product of the process of claim 31, comprising:
said media parser; and
further comprising at least one member of marking group consisting of:
said marker;
said mark reader; and
said unmarker.

33. An authenticating/copyright engine for a digital recording device comprising:
said media format engine, of claim 32 coupled by an first interface coupling to a first removable memory coupling of said digital recording device;
said media format engine further coupled to a second interface coupling supporting communications with a second removable memory coupling for a second removable memory module.

34. The apparatus of claim 33, wherein said digital recording device includes at least one of a digital audio recording device, a digital camera and a video camera.

35. The apparatus of claim 33, a first of said removable memory modules which can interface to said first removable memory module is incompatible with said second removable memory module.

36. The apparatus of claim 33, a first of said removable memory modules which can interface to said first removable memory module is compatible with said second removable memory module.

37. A digital recording device comprising: said media format engine, of claim 32 coupled by second interface coupling supporting communications with a second removable memory coupling for a second removable memory module;
wherein said digital recording device includes at least one of a digital audio recording device, a digital camera and a video camera.

38. A multi-channel stream mark reading system, comprising:
at least two of said media format engines, of claim 32, coupling to at least one distributed wideband signal, and further coupling to at least one mark accounting system;
wherein each of said media format engines includes said mark reader;
wherein each of said at least two media format engines report via said coupling to said mark reader an occurrence of a marking message read from an instance of said media format provided by said distributed wideband signal.

39. The apparatus of claim 38, wherein, for each of said media format engines, said coupling of said media format engine, to said distributed wideband signal, further comprises:
said distributed wideband signal is coupled to a channel decoder, which provides said media format instance to said media format engine.

40. The apparatus of claim 38, further comprising a wideband interface creating said distributed wideband signal.

41. The apparatus of claim 38, wherein said wideband interface connect to at least one of a wireless broadcast interface and a wireless broadcast service.

42. The apparatus of claim 38, wherein said wireless broadcast interface includes at least one of a radio antenna interface, a television antenna interface, and a satellite antenna interface;
wherein said wireless broadcast service includes at least one interface to at least one of a residential broadband network, the internet, a version of ethernet, and a cable television distribution network.

43. A business method using the apparatus of claim 38, comprising the steps of:
a service user requesting a report of said occurrence of said marking message, including a commitment to provide a service revenue to a service provider; and
said mark accounting system of at least one of said multi-channel stream mark reading systems responds to at least partly create said report based upon commitment;
wherein said service provider performs at least one member of the group consisting of:
said service provider maintains at least one of said multi-channel stream mark reading systems;
said service provider owns at least one of said multi-channel stream mark reading systems; and
said service provider manages at least one of said multi-channel stream mark reading systems.

44. The method of claim 43, wherein the step said service user requesting said report is further comprised of the step of:
said service user requesting said report through an interaction with a service user interface.

45. The method of claim 44,
wherein a second service provider performs at least one member of the group consisting of:
said second service provider maintains said service user interface;
said second service provider owns said service user interface; and
said second service provider manages said service user interface.

46. A business method using the apparatus of claim 32, comprising the steps of:
a media user requesting delivery of a marked instance of a media format, including a commitment to provide a service revenue to a service provider; and
providing at least one of said media format engines an instance of said media format and a copyright data referring to said media user to create said marked instance of said media format;
wherein said at least one media format engine includes at least one of said markers for said media format;
wherein said service provider performs at least one member of the group consisting of:
said service provider maintains at least one of said media format engine;
said service provider owns at least one of said media format engine; and
said service provider manages at least one of said media format engine.

47. The method of claim 46, further comprising the step of:
a copyright holder providing said media format instance based upon receiving a copyright revenue at least partly from said service revenue.

48. The method of claim 31,
wherein the step generating said mark reader is further comprised, for at least one of said mark profiles, of the step of:
generating said mark reader using said field encoding specifier of said at least one mark profiles to decode a field of said field length from a flat area based upon at least one of said statistical profile components.

49. The method of claim 31,
wherein the step generating said unmarker is further comprised, for at least one of said mark profiles, of the step of:
generating said unmarker using said field encoding specifier of said at least one mark profiles to remove a field of said field length from a flat area based upon at least one of said profile components.

50. The method of claim 31, further comprising the step of:
generating a hash code calculator for an instance of said media format to create a hash code based upon said media format instance.

51. The method of claim 50, further comprising the step of:
generating a copyright data acquirer to create at least one copyright data presented to said marker.

52. The method of claim 51, wherein the step generating said hash code calculator is further comprised of at least one of the steps of:
generating said hash code presented to said copyright data acquirer; and
generating said hash code presented to said marker.

53. The method of claim 1, wherein said statistical profile list includes a first of said profile components and a second of said profile components.

54. The method of claim 53, wherein the step generating said region recognizer is further comprised of the step of:
generating said region recognizer based upon said first profile component and based upon second profile component.

55. The method of claim 54, wherein the step generating said flat area discriminator is further comprised of the step of:
generating said flat area discriminator based upon said flatness specifier of said second profile component.

56. The method of claim 53, wherein the step generating said region recognizer is further comprised of the step of:
generating a first of said region recognizers based upon said first region recognizer and upon said first profile component; and
generating a second of said region recognizers based upon second profile component.

57. The method of claim 56, wherein the step generating said flat area discriminator is further comprised of the step of:
generating said flat area recognizer further based upon said flatness specifier of said second profile component.

58. The method of claim 56, wherein the step generating said flat area discriminator is further comprised of the step of:
generating a first of said flat area recognizers based upon said first region recognizer and upon said flatness specifier of said first profile component; and
generating a second of said flat area recognizers based upon said second region recognizer and upon said flatness specifier of said second profile component.

59. An apparatus implementing the method of claim 1, comprising, for each step of the method, means for implementing said step.

60. The apparatus of claim 59, wherein at least one of said means includes a computer accessibly coupled to a memory; wherein said computer is controlled by a program system at least partly implementing said step for said means.

61. An article of manufacture communicating the method of claim 1, comprising a memory containing a program system;
wherein said program system includes, for each step of the method, at least one program step for implementing said step.

62. The article of claim 61, wherein said memory is a non-volatile memory.

63. The article of claim 61, wherein said memory is a file.

64. The article of claim 61, wherein said memory further contains at least one of said media format, and said statistical profile list.
